(19) United States
(12) Patent Application Publication
(10) Pub. No.: US 2025/0328301 A1
(43) Pub. Date: Oct. 23, 2025

(54) SYSTEMS AND METHODS FOR SEAMLESS USER INTERFACE RENDERING USING MULTIPLE PROCESSORS OF A DEVICE

(71) Applicant: Meta Platforms Technologies, LLC, Menlo Park, CA (US)

(72) Inventors: Brian Richard Costabile, San Diego, CA (US); Tarun Reddy Karra, Austin, TX (US); Shubhraprakash Das, Fremont, CA (US); Nir Bruner, London (GB); Michael Robert Fitz, New York, NY (US); Daniel Aminzade, Sunnyvale, CA (US)

(21) Appl. No.: 19/174,873

(22) Filed: Apr. 9, 2025

Related U.S. Application Data
(60) Provisional application No. 63/636,008, filed on Apr. 18, 2024.

(51) Int. Cl. G06F 3/14; G06F 3/0484

(52) U.S. Cl. CPC G06F 3/14; G06F 3/0484

(57) ABSTRACT

A method for providing seamless transitions between different user interfaces using multiple processors of a single device is described. The method includes causing, by a first processor of the device, display of a first user interface and receiving a user input requesting display of a second user interface instead of the first user interface. In accordance with determining that the user input request requires performance of an operation that does not satisfy processor performance criteria, the method includes sending, by the first processor and to a second processor, a wake-up message based on the user input. The first processor causes, based on the user input, partial display of the second user interface. In conjunction with handing-off display control for the second user interface to the second processor, the method causes the second processor, to display a complete second user interface.

### RELATED APPLICATIONS

This application claims priority to U.S. Prov. App. No. 63/636,008, filed on Apr. 18, 2024, and entitled “Systems and Methods for Seamless User Interface Rendering Using Multiple Processors of a Device,” which is hereby incorporated by reference in their entirety.

### TECHNICAL FIELD

The systems and methods disclosed herein relate generally to the seamless display of user interfaces using multiple processors, including but not limited to techniques for minimizing user interface hard seams caused by user interface hand-off transitions between different processors.

### BACKGROUND

User devices such as smartwatches, artificial reality, virtual reality, and augmented reality devices often include multiple processors configured for running different applications and/or background processes. Existing solutions use a first processor for providing an Always-On-Display (AOD) and a second processor with greater processing capabilities and complex hardware interfaces, such as a system in package (SIP) processor, for providing other requested user interfaces. The first processor is generally programmed for handling a specific task (e.g., rendering the AOD user interface) and has limited processor functionality. For rendering other user interfaces, the second processor is selected, and the first processor hands-off control related to user interface rendering and/or user input analysis to the second processor. Further, these solutions rely on the second processor reverting user interface control back to the first processor when rendering is related to the specific task (e.g., the AOD user interface). However, user interface transitions from graphically intensive and interactive user interfaces to a simple AOD user interface appear abrupt with hard visual seams as the user device transitions user interface control from the second processor to the first processor. In many cases, the abrupt user interface transitions introduce subpar rendering and a less-than-ideal visual user experience. Further, as user applications (e.g., artificial reality applications) become more interactive and graphically intensive, rendering of all user interfaces except the one requiring minimal processor functionality (e.g., the AOD user interface) will significantly increase the power consumption burden on device batteries, shortening device usage times between charging cycles, and adversely affect the user experience.

As such, there is a need to address one or more of the above-identified challenges. A brief summary of solutions to the issues noted above are described below.

### SUMMARY

The methods, systems, and devices described herein address one or more of the above-mentioned drawbacks by allowing a user wearing wearable devices, such as a wrist-wearable device, an artificial-reality headset, and/or other device, to engage with an artificial environment in an immersive and interactive manner by seamlessly transitioning user interface control between a first processor and a second processor for a variety of applications and graphically interactive features (e.g., using a microcontroller unit (MCU) with limited processor functionality) to seamlessly cause display of multiple user interfaces and/or user interface elements based on pre-coordinated, pre-rendered, and/or synchronized user interface elements. This approach extends use of the first processor for rendering and/or causing display of more complex user interfaces and/or user interface elements thereby lowering device power consumption, extending device battery life, minimizing device reliance on more complex memory and logic circuitry, and enhancing the user experience. Further, use of the first processor for handling complex graphical rendering operations minimizes hard visual seams in user interface transitions if the user device needs to switch control from the second processor to the first processor (or vice versa). Further, the systems and methods described herein can use the greater functional capabilities of the second processor to pre-render user interface elements based on pre-coordinated user interface layouts and/or real-time synchronization protocols established between the first processor and the second processor. The pre-rendered user interface elements can be sent to the first processor based on the synchronization protocols, operational capabilities of both processors, and/or requested user interface functionality to enable the first processor to render complex user interfaces and process complex interactive applications in real-time without needing to hand-off user interface control to the second processor.

In this way, the user device is able to provide an immersive, enjoyable, and seamless user experience in a more efficient manner while extending battery life and minimizing the use of more expensive, second processors with larger footprints. For example, enabling the first processor to receive, process, and/or analyze a greater variety of user interactions with different user interfaces can enable the user device to consume lower power by relying on the first processor to render and/or cause display of a greater variety of user interface screens and/or user interface elements and/or process a greater variety of user interface applications.

In some embodiments, methods and systems herein describe a first processor causing display of a first user interface. The method includes receiving a first user input requesting display of a second user interface instead of the first user interface. In accordance with determining that the first user input request requires performance of an operation that does not satisfy first processor performance criteria, sending, by the first processor and to a second processor, a first wake-up message based on the first user input. The first processor then causes, based on the first user input, partial display of the second user interface. The method further describes causing, by the second processor, a complete display of the second user interface in conjunction with receiving display control for the user interface from the first processor.

In some embodiments, a system comprising a first processor, a second processor communicatively coupled to the first processor, a first non-transitory memory coupled to the first processor storing one or more programs configured for execution by the first processor, and a second non-transitory memory coupled to the second processor storing one or more configured for execution by the second processor is described. The first non-transitory memory stores the one or more programs including instructions for causing display of a first user interface, receiving a first user input for the first user interface, wherein the first user input requests display of a second user interface instead of the first user interface. The one or more programs of the first non-transitory memory further include instructions that in accordance with determining that the first user input request requires performance of an operation that does not satisfy first processor performance criteria, sending, by the first processor and to the second processor, a first wake-up message based on the first user input, and causing, based on the first user input, partial display of the second user interface. The second non-transitory memory stores the one or more programs including instructions for receiving the first wake-up message and causing a complete display of the second user interface.

In some embodiments, the first non-transitory memory coupled to the first processor further stores instructions for prior to receiving the first user input, receiving, from the second processor, a first set of pre-rendered user interface elements for the second user interface, wherein causing, by the first processor, the partial display of the second user interface is based on rendering at least a portion of the first set of pre-rendered user interface elements for the second user interface.

In some embodiments, the second non-transitory memory coupled to the second processor further stores instructions for receiving a second user input requesting display of a third user interface instead of the second user interface, and in accordance with determining that the second user input requests performance of an operation that satisfies the first processor performance criteria, sending, to the first processor, a second wake-up message based on the second user input.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1D illustrate an example seamless user interface transition between two processors, in accordance with some embodiments.

FIG. 1E illustrates an example timing diagram for FIGS. 1A-1D, in accordance with some embodiments.

FIGS. 2A and 2B illustrate an example seamless user interface transition between two processors, in accordance with some embodiments.

FIG. 2C illustrates an example timing diagram for FIGS. 2A and 2B, in accordance with some embodiments.

FIGS. 3A and 3B illustrate an example seamless user interface transition between two processors, in accordance with some embodiments.

FIGS. 4A-4D illustrates an example seamless user interface transition between two processors, in accordance with some embodiments.

FIG. 4E illustrates an example timing diagram for FIGS. 4A-4D, in accordance with some embodiments.

FIGS. 5A and 5B illustrates an example seamless user interface transition between two processors, in accordance with some embodiments.

FIG. 6 illustrates an example flow chart for the seamless user interface transition between two processors, in accordance with some embodiments.

FIG. 7 illustrates an example flow chart for the seamless user interface transition between two processors, in accordance with some embodiments.

FIGS. 8A and 8B illustrate an example flow chart for the seamless user interface transition between two processors, in accordance with some embodiments.

FIGS. 9A-9C-2 illustrate example artificial-reality systems, in accordance with some embodiments.

FIGS. 10A and 10B illustrate an example wrist-wearable device 1000, in accordance with some embodiments.

FIGS. 11A-11C illustrate example head-wearable devices, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with distinct types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing application specific interface (API) providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

As described herein, one or more machine-learning systems determine, based on a user input, user intent and generate a visual representation of a user, such as an avatar sticker, that expresses the user intent. The methods and devices described herein utilize textual data presented and/or received at a user device to determine a user intent in responding to a portion of the textual data and generate one or more visual representations of the user intent. The visual representations of the user intent can include a representation of the user (e.g., an avatar) and an expression of the user intent performed by the representation of the user. As described herein, the visual representations of the user intent can be shared with other users and/or stored for future use.

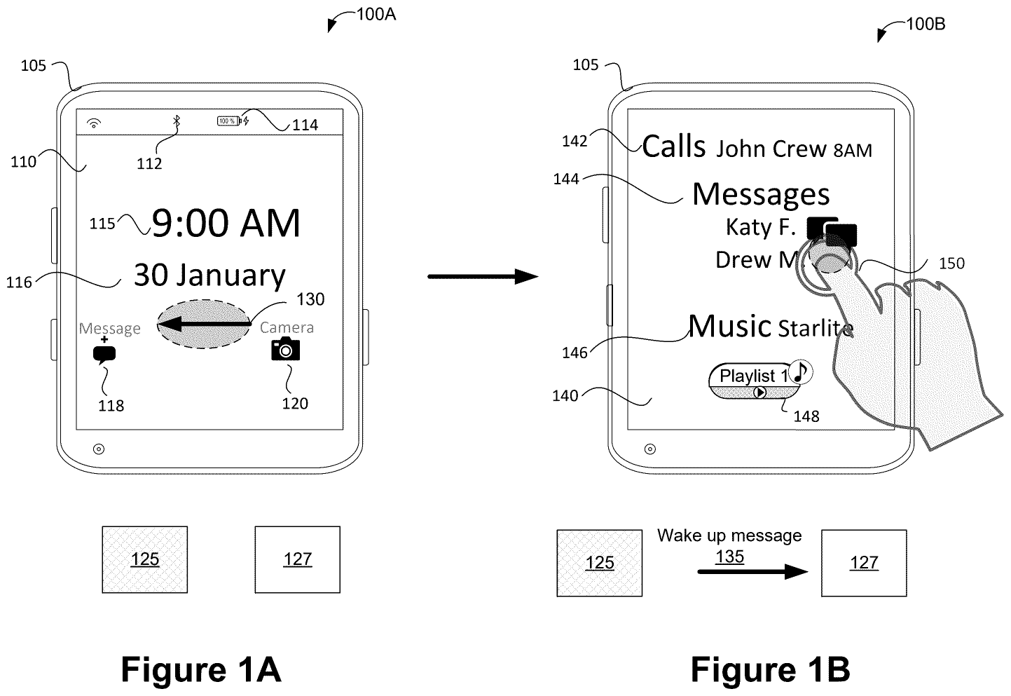

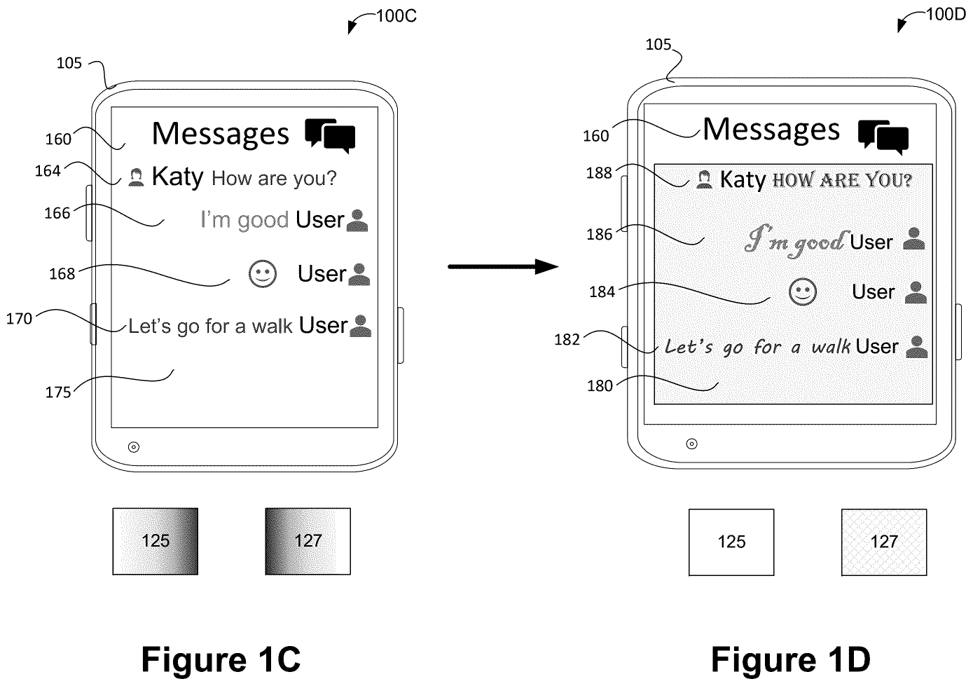

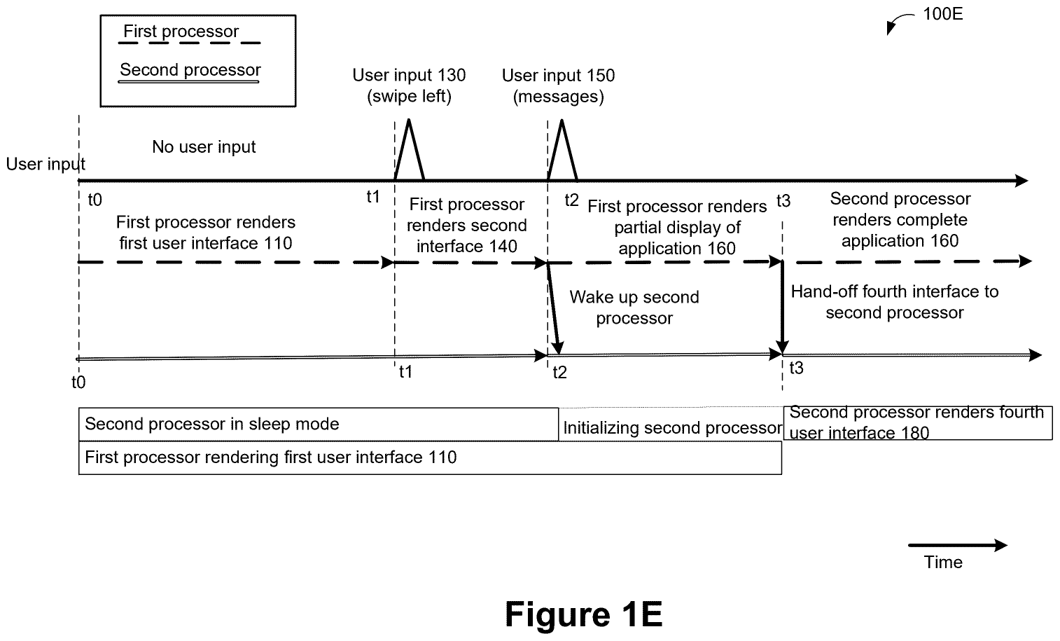

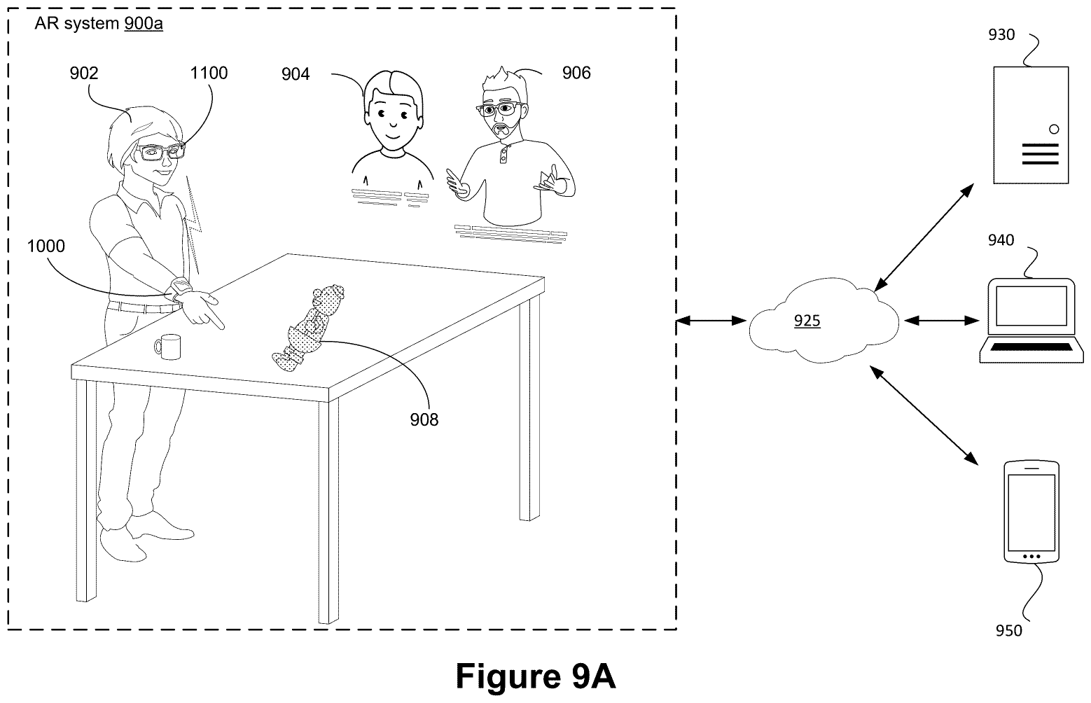

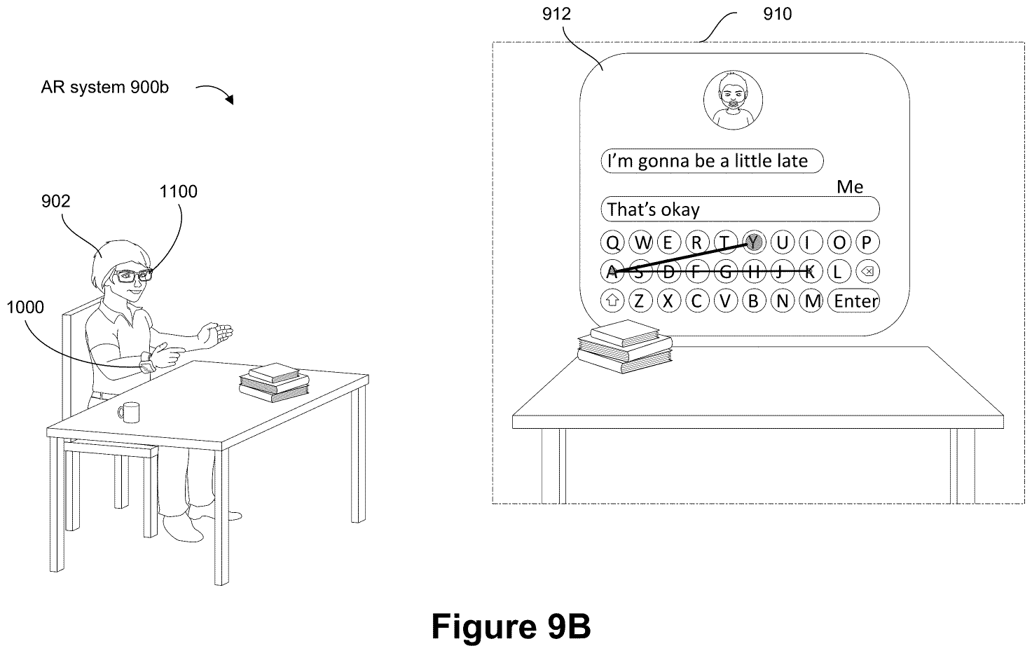

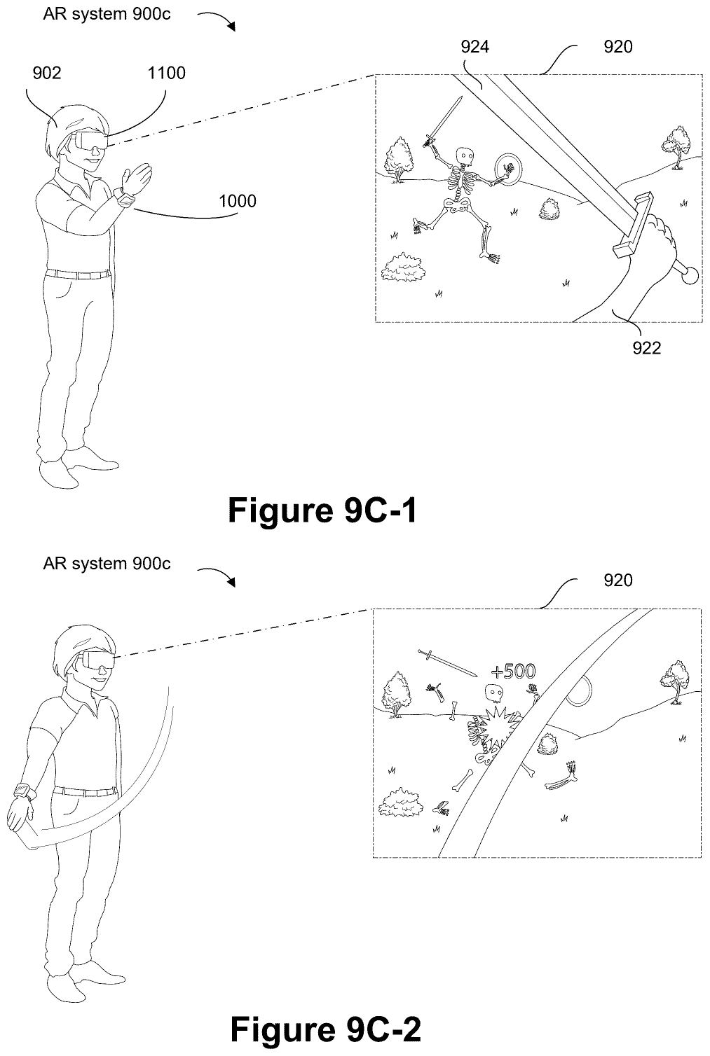

FIGS. 1A-1D illustrate an example of sequential user interface changes 100A-100D based on user input, in accordance with some embodiments. A user device 105 (analogous to wrist-wearable device 1000, AR device 1100 and/or VR device 1110; FIGS. 9A-11C) is configured to present multiple user interfaces 110, 140, 175 and 180 to a user based on user inputs (e.g., a first user input 130 and a second user input 150). The user device 105 includes at least a first processor 125 (e.g., a low-power processor, such as a microcontroller unit (MCU)) and a second processor 127 (e.g., a high-power processor, such as system on chip (SOC) or system in chip package (SIP) processor). The first processor 125 and the second processor 127 can be configured to operate in various power modes (e.g., low power mode, high power mode, sleep state, transitioning state, initialization state, etc.) depending upon a type (e.g., logic, memory, input/output, sensor hardware, network hardware, etc.) and/or number of processing circuitry blocks that are active (e.g., powered On). The user device 105 and/or electronic devices communicatively coupled with the user device 105 (e.g., any device shown and described below in reference to FIGS. 9A-11C) include instructions and/or programs stored in memory that, when executed by the first processor and the second processor, cause the performance of the operations of the sequential user interface changes of 100A-100D.

In accordance with some embodiments, the first processor 125 and/or the second processor 127 are configured to coordinate operations performed at the user device 105, such as the rendering and presentation of user interfaces by the user device 105. The first processor 125 and/or the second processor 127 coordinate operations based on commands available to a user of the user device 105. For example, without limitation, the commands available to the user of the user device 105 can include initiating different applications, services (e.g., device screentime, weather feeds, emergency notifications, device tracking, etc.), devices (e.g., cameras, sensors, etc.) and/or interactions (e.g., social media livestreams, video calls, video messaging, AR interactions, etc.) using the user device 105. By synchronizing and/or coordinating user interface control between the first processor 125 and the second processor 127, the disclosed systems and methods allow for seamless user interface transitions based on user inputs at the user device 105 that provide the user with intuitive, efficient, and enjoyable user experiences. As described below, the systems and methods disclosed herein enable coordinated, synchronized, and efficient use of the first processor 125 and the second processor 127 by seamlessly cycling between the two processors depending on user input, which improves the user experience by providing seamless user interface transitions and optimizing battery power consumption. FIGS. 1A-1D described below provide examples of seamless user interface transitions based on rendered and displayed user interfaces, via the first processor 125 and/or the second processor 127 and vice versa, responsive to the first user input 130 and the second user input 150.

FIG. 1A shows a first sequential user interface change 100A presented via the user device 105. The user device 105 displays a first user interface 110 (e.g., an Always On Display (AOD)). The first user interface 110 includes one or more user interface elements, such as a battery life user interface element 114, network connection user interface elements (e.g., a Bluetooth connectivity user interface element 112, a Wi-Fi connectivity user interface element, a cellular connectivity user interface element, etc.), a current date user interface element 116, and/or a current time user interface element 115, as well as user-selectable user interface elements (e.g., user interface elements associated with a command, such as imitation of an application or device (e.g., a messaging application represented by the messaging application icon 118, a camera application represented by the camera application icon 120, etc.).

In some embodiments, the first processor 125 causes display of the first user interface 110 by rendering and providing for display the user interface elements (e.g., current time user interface element 115, current date user interface element 116, battery life user interface element 114, network connectivity user interface elements, messaging application 118, camera application 120, etc.) for the first user interface 110. While the first user interface 110 is displayed, the user device 105 is configured to receive one or more user inputs (e.g., auditory, optical, physical touch, and/or EMG-based inputs (finger taps based on neuromuscular signals), etc.) associated with the first user interface 110. While the first processor 125 renders and causes display of the first user interface, the first processor 125 is in an active or “On” state (represented by shading of the first processor 125 in FIG. 1A) and the second processor 127 is in a low-power state, a sleep mode, a stand-by mode, or other low-power operational mode (generally referred to as an inactive or “Off” state and represented by unshaded second processor 127 in FIG. 1A). In some embodiments, while the second processor 127 is in the inactive state, the second processor 127 can provide the first processor 125 with pre-rendered user interface elements and/or pre-coordinated user interface elements for the first user interface 110, and the first processor 125 can cause display of the (locally) rendered user interface elements, the pre-rendered user interface elements, and/or the pre-coordinated user interface elements when causing presentation of the first user interface 110. The pre-rendered and/or pre-coordinated user interface elements associated with the first user interface 110 can be generated by the second processor 127 and sent to the first processor 125 before entering into the inactive state.

Alternatively, or in some additional embodiments, the pre-rendered and/or pre-coordinated user interface elements are generated by the second processor 127 and stored in a memory shared with the first processor 125. Memory cache coherence protocols can help ensure synchronization between the first processor 125 and the second processor 127 for managing the generation, rendering, storage, re-writing, and/or retrieval of required user interface elements. Selection of user interface elements for shared memory storage can be based on determining correspondence between a user input received at a particular user interface and a corresponding command or operation associated with the user input, determining whether the user input request requires performance of an operation that does not satisfy processor performance criteria (e.g., hardware and/or software performance criteria for the first processor), and/or determining whether the first processor 125 can simplify a graphical user element for display and still provide the required user experience in a functionally pleasing manner.

For example, the processor performance criteria can include an ability to drive one or more applications respectively corresponding to the application icons rendered by a user interface. In some embodiments, the processor performance criteria can include an ability to drive a camera application respectively connected to user selection of the camera application icon 120 and/or the messaging application icon 118. A user input selecting either the camera application icon 120 and/or the messaging application icon 118 can trigger rendering and/or processing of the respective applications (e.g., stand-alone or in conjunction with other applications) via another user interface. The ability to drive the one or more applications can be based on the hardware components of the first processor such as type and/or amount of memory storage available, functional logic blocks, input/output data transfer speeds, number of input/output ports, hardware connections to one or more sensors (e.g., camera, heartrate sensor, oxygen sensor, etc.), hardware connections to network interface elements (e.g., cellular, wi-fi, personal area network, virtual private network, etc.).

Alternatively, or in addition, in some embodiments, determining whether the first processor performance criteria are satisfied can further be based on identifying the respective user interface elements to be rendered and/or provided for the next user interface by analyzing the user input and identifying the corresponding next user interface based on the analyzed user input.

In some embodiments, determining whether the user input requires performance of an operation that does not satisfy processor performance criteria is based on identifying pre-rendered and/or pre-coordinated user interface elements provided by the second processor 127 to the first processor 125 that enables the first processor 125 to render the display user interface elements and/or analyze user interaction(s) associated with the graphically intensive user interface elements without needing to hand-off user interface control to the second processor 127. For example, the second processor 127 sends pre-rendered and pre-coordinated user interface elements to the first processor 125 directly. The first processor 125 then stores the pre-rendered and pre-coordinated user interface elements in program memory that is contained in the first processor 125.

Alternatively, or addition, in some embodiments, determining whether the user input requires performance of an operation that does not satisfy processor performance criteria is based on identifying pre-rendered and/or pre-coordinated user interface elements provided by the second processor 127 to a memory shared with and/or accessible by the first processor 125. For example, the second processor 127 sends pre-rendered and pre-coordinated user interface elements to the shared memory for storage. The pre-rendered and pre-coordinated user interface elements are then accessible at a later point in time by either the first processor 125 or the second processor 127.

As shown in FIG. 1A, the user device 105 detects a first user input 130 (indicative of a left swipe) performed at the first user interface 110. The first processor 125 determines whether the first user input 130 performed at the first user interface 110 requests display of another user interface. The first processor 125 can determine whether the request to display of the other user interface requires performance of an operation that does not satisfy processor performance criteria for the first processor 125. For example, the first processor 125 can determine that processor performance criteria required to render one or more applications (e.g., music application) for the requested user interface are satisfied based on accessing a pre-coordinated list of applications and/or user interface elements associated with the left swipe user input received at the first user interface.

FIG. 1B shows a second sequential user interface 100B presented via the user device 105. The user device 105 displays a second user interface 140 in response to the first user input 130 shown in FIG. 1A. In some embodiments, the second user interface 140 includes user interface elements associated with graphical previews for one or more applications such as call history 142 (e.g., most recent call from “John Crew”), messages history preview 144 (e.g., two recent message contacts “Katy F.” and “Drew M”), and/or mini-window control for a music streaming application 146 “Starlite” showing most recent playlist 148 “Playlist 1.” In some embodiments, in accordance with a determination that presentation of the second user interface 140 by the first processor 125 would satisfy the processor performance criteria (e.g., for the first processor 125), the first processor 125 renders and causes presentation of substantially all, or all, of the second user interface 140 and/or user interface elements of the second user interface 140. In continuing to cause display of the second user interface 140, the first processor 125 remains in the active state (shaded representation in FIG. 1B) and the second processor 127 can remains in the inactive state (unshaded representation in FIG. 1B). As described, in some embodiments, the first processor 125 can use pre-rendered potions of a user interface, such as the second user interface 140, to cause presentation of a user interface.

Alternatively, in some embodiments, the first processor 125 partially renders and causes display of a partial second user interface 140 without causing display of graphically intensive portions of the second user interface 140 (e.g., portion that require high bandwidth data transfer between one or more sensors of the user device 105). In some embodiments, the first processor 125 partially renders and causes display of a partial second user interface 140 based on the processor performance criteria not being satisfied, such as the first processor 125 lacking logic, memory, input/output, and/or other hardware protocols for interfacing with (or controlling) one or more sensors of the user device 105. For example, the first processor 125 can determine that the message history preview 144 can be displayed in a more graphically pleasing manner based on the user's stylistic font preferences but lacks memory access to the preferred font styles. The first processor 125 can then render and cause display of simplified graphical user interface elements, such as the message history preview 144, based on selecting less memory intensive font styles (e.g., Arial, Times New Roman, etc.). The less memory intensive font styles can be part of a group of graphical parameters, related to the rendering of user interfaces, which are available to the first processor for modification purposes. For example, a routinely used font style (e.g., Arial) can be chosen by the first processor to modify an application recommended font style to enable rendering of the application related user interface elements (e.g., a message and/or message preview). This avoids the need to transition control to the second processor 127 (e.g., System On Chip (SOC), SIP, graphics processing unit (GPU), etc.). Instead, the first processor 125 continues to render, control, and/or cause display of the second user interface 140 using simplified graphical features and/or simplified user interface elements while conserving device battery.

In some embodiments, the user interface elements are generated by the second processor 127 and sent to the first processor 125 before the second processor 127 transitions into the inactive state. While the second processor 127 is in the inactive state, the first processor 125 can provide the second processor 127 with synchronization data such that the second processor 127 can pre-render and/or provide pre-rendered data to the first processor 125 that is responsive to user inputs. For example, the second processor 127 can pre-render (and/or generate) the user interface elements based on (i) currently active user interface applications being rendered, (ii) predicting a list of future applications to be rendered depending on a correspondence between a type of user input that can be received at the currently active user interface and processor performance criteria for the first processor and the second processor, and/or (iii) synchronization protocols associated with the first processor 125 and the second processor 127.

For example, synchronizing user interface control between the first processor 125 and the second processor 127 is based on the first processor 125 determining at type of user input (e.g., the first user input 130) performed and a current user interface presented (e.g., the first user interface 110) when the user input was detected. The first processor 125 can then send synchronization data, using one or more communication protocols, to the second processor 127. Synchronization between the first processor 125 and the second processor 127 can further be based on synchronization clock signals (e.g., local timing oscillators, external timing signals, etc.) respectively associated with the first processor 125 and the second processor 127.

Alternatively, or in addition, in some embodiments, the second processor 127 can pre-render user interfaces and/or user interface elements based on a current user interface presented when the user input is detected, a predetermined number of inputs detected from a particular user interface (e.g., two sequential inputs from an AOD), a type of user input detected (e.g., swipe, single input, double input, maintained input, etc.), sequence of user inputs (e.g., swipe followed by tap, three consecutive taps, etc.), etc.

As further shown in FIG. 1B, the user device 105 detects a second user input 150. The first processor 125 determines whether the second user input 150 requests for the display of a third user interface (e.g., a stand-alone messaging application corresponding to the messages history preview 144) or another operation to be performed by the user device 105. The first processor 125, in accordance with a determination that the second user input 150 is associated with performance of one or more operations (e.g., initiating a stand-alone messaging application, controlling a back-lit display of the user device 105, providing graphically intensive font styles, providing preview of a video message, etc.) that would not satisfy the processor performance criteria, provides the second processor 127 a wake-up message 135. The wake-up message can be configured to cause the second processor 127 to transition from the inactive state to an active or “On” state (e.g., from an inactive state as shown in FIGS. 1A and 1B, to a transitionary state as shown in FIG. 1C, and further to an active state as shown in FIG. 1D). In some embodiments, the wake-up message 135 provides additional synchronization data related to type of user input received and/or the requested user interface transition. User interface transitions responsive to the second user input and based on the determination that the first processor 125 cannot satisfy the processor performance criteria are described with respect to FIGS. 1C-1D below.

FIGS. 1C-1D show user interface control transitioning from the first processor 125 to the second processor 127 responsive to the wake-up message 135 sent by the first processor 125, to the second processor 127, as described above with respect to FIG. 1B. In some embodiments, the first processor 125 can determine that the stand-alone messaging application 160 requires one or more user elements that cannot be simplified without sacrificing functionality and/or degrading user experience. Alternatively, or additionally, in some embodiments, the first processor 125 can determine that the processor performance criteria are not satisfied because the first processor 125 lacks the necessary hardware, memory, logic, input/output, and/or data transfer speeds for providing the messaging application user interface 180.

FIG. 1C shows a third sequential user interface change 100C of a user interface 175 rendered by the first processor 125 as the second processor 127 transitions to an active state and the first processor 125 prepares to hand-off user interface control to the second processor 127. Transitional states of the first processor 125 and the second processor 127 are represented as shaded gradients in Figure IC. In some embodiments, the third user interface 175 is a partial user interface associated with the messaging application 160. For example, the first processor 125 renders and/or causes display of messages (e.g., 164 “How are you,” 166 “I′m good,” 170 “Let's go for a walk,” etc.) and message recipients (e.g., “Katy”) by using frequently used and less graphically intensive font types. In some embodiments, the first processor 125 and/or the second processor 127 cause display of graphical elements 168 (e.g., emoticons, emojis, avatars, stickers, etc.) associated with the messaging application 160.

In some embodiments, the third user interface 175 is partial user interface for the messaging application 160 that is provided by the first processor 125 based on pre-rendered user interface elements generated by the second processor 127 and/or partially rendered by the first processor 125. For example, the second processor 127 can pre-render user interface elements associated with a layout of the messaging application 160 such as labels, icons, textual content, and/or various graphical elements. In some embodiments, the pre-rendered user interface elements can be stored in shared memory and accessed by the first processor 125 after receiving the second user input 150. Alternatively, or additionally, the pre-rendered user interface elements can be provided directly by the second processor 127 and to the first processor 125 after the second processor 127 receives the wake-up message. For example, the second processor 127 receives the wake-up message 135, completes an initialization process, receives information about the requested third user interface 175, renders at least a portion of the graphical elements, such as elements 164, 166, 168, and/or 170, and sends the rendered portion of the graphical elements to the first processor 125 and/or causes the display of the rendered portion of the graphical elements.

FIG. 1D shows an example 100D of a complete user interface 180 for the messaging application 160 provided by the second processor 127, in accordance with some embodiments. In some embodiments, transfer of user interface control has been completed from the first processor 125 to the second processor 127. The first processor 125 can be in an inactive state (as represented by an unshaded region in FIG. 1D) and the second processor 127 can be in the active state that is configured to render and cause display of the fourth user interface 180.

In some embodiments, display of the messaging application 160 via the fourth user interface 180 involves the second processor 127 activating a backlight for the display of the user device 105, enabling logic and/or memory intensive font styles (e.g., 188 “How are you?,” 186 “I′m good,” 182 “Let's go for a walk,” etc.) for displaying textual content, video based messages, etc. As described above, control of the rendering and display of user interfaces is transferred from the first processor 125 to the second processor 127 in response to a determination, by the first processor 124, that display of at least the third user interface 175 (and the fourth user interface 180) would not satisfy the processor performance criteria. In some embodiments, the first processor 125 determines whether the second processor 127 would satisfy the processor performance criteria before transition control to the second processor 127, or if control should be shared between the first and second processor 125 and 127 or provided to another processor (e.g., another processor on the user device 105 or a processor of a communicatively coupled device, such as any device described below in reference to FIG. 9A).

FIG. 1E shows an example timing diagram 100E of synchronization messages exchanged between the first processor 125 and the second processor 127, in accordance with some embodiments. At start time (t0) the second processor 127 is in inactive state and the first processor 125 is in an active state. The active state of the first processor 125 allows the first processor 125 to render and cause display of the first user interface 110 as described above with respect to FIG. 1A. While the first processor 125 is the active state, the first processor 125 monitors the user interface for any user interactions. At time (t1), the first user interface 110 detects the first user input 130, as described above with respect to FIG. 1A, requesting display of the second user interface 140. The first processor 125 analyzes the first user input 130 to identify the requested user interface and the corresponding applications, services, and/or other functions required for providing the requested user interface. Based on the operations associated with the first user input 139 and/or the first user interface 110, the first processor 125 determines that the user requested for the display of the second user interface 140. If the first processor 125 then determines that the processor performance criteria for causing display of the second user interface 140 are satisfied, the first processor 125 continues to control the user interface transition from the first user interface 110 to the second user interface 140. For example, the first processor 125 determines that the performance criteria required to render and cause display of the second user interface 140 can be met by logic, memory, input/output interfaces, etc. associated with the first processor 125.

At time (t2), the first processor 125 receives the second user input 150 associated with the display of the third user interface 140. As described above with respect to FIG. 1B, the first processor 125 determines that the second user input 150 requests display of the messaging application 160 and that the first processor 125 does not meet the processor performance criteria for causing display of substantially all, or all of the messaging application 160. The first processor 125 then sends the wake-up message 135 to the second processor 127 to notify the second processor 127 that the user has requested display of a user interface for which the first processor 125 does not meet the required performance criteria.

After receiving the wake-up message 135 around time (t2), the second processor 127 begins an initialization process. While the second processor 127 is undergoing initialization, the first processor 125 can remain in control of the rendering and causing display of a partial user interface and/or user interface application. In some embodiments, during the initialization process, the second processor 127 receives additional synchronization data from the first processor 125. The second processor 127 can determine the processor performance criteria required for rendering and causing display of the complete messaging application 160 based on the additional synchronization data received. In some embodiments, the second processor 127 can render and provide user interface elements for enabling the first processor 125 to provide partial display of the messaging application 160 during the initialization process. In some embodiments, the initialization process of the second processor 127 can be a transitionary state during which user interface control is gradually and seamlessly transferred from the first processor 125 to the second processor 127.

At time (t3), the second processor 127 completes the initialization process and is in active state. In some embodiments, a messaging protocol establishing a start, and an end time of the initialization process can be used to synchronize the user interface controls between the first processor 125 and the second processor 127. In some embodiments, the initialization time can be a predetermined wait time based on determining a percentage of overlap between the user interface displayed by the first processor 125 as the partial display of the application 160 and the complete user interface displayed by the second processor 127 for the application 160. For example, if the first processor 125 handles the rendering and/or display of over 50% of the application 160 and less than 50% needs to be transitioned over to the second processor 127, the predetermined wait time can be lower than that required if the first processor 125 handles the rendering and/or display of less than 20% of the application 160.

In alternative embodiments, the predetermined wait time can be based on a type of hardware control that needs to be activated. For example, if the fourth user interface 180 requires enabling and/or controlling an AR/VR application, the predetermined wait time can be longer. This can help smoothen the transition between the first processor 125 and the second processor 127 with the first processor 125 continue to render portions of the AR/VR application that require lower memory and/or data bandwidth and processing power and handing over complete user interface control to the second processor 127 after the second processor 127 has established control over the AR/VR devices through connected hardware, logic, memory, and/or network interfaces and based on the functional requirements of the AR/VR application.

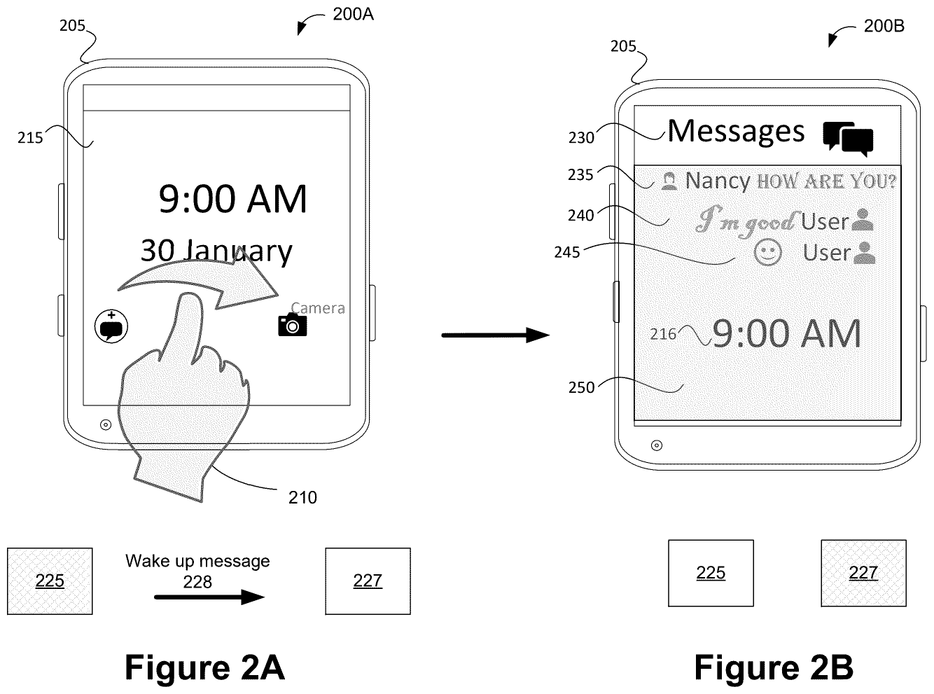

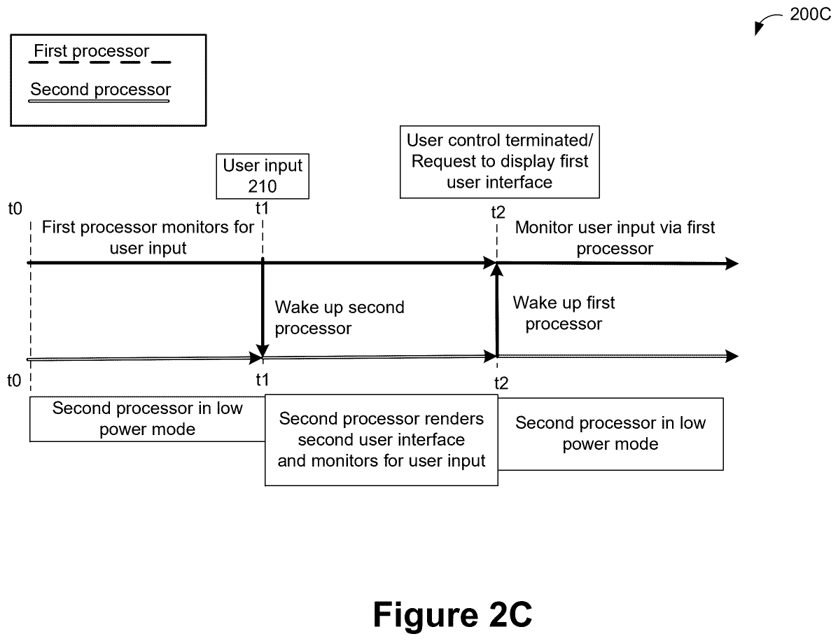

FIGS. 2A and 2B illustrate an example user interface transition 200A and 200B that is hidden behind a user input for a user device 205, in accordance with some embodiments. For example, the user input 210 is a swipe screen gesture that causes user interface 215 to seamlessly transition to user interface 250. In another example, the user input 210 can be a complex user interaction that includes command operations requiring one or more processor performance criteria that cannot be met by the first processor 225, but can be met by the second processor 227 that has advanced processor capabilities and network interfaces.

FIG. 2A shows an example user interface 215, for the user device 205, receiving a user input 210, in accordance with some embodiments. The user input 210 can be a swipe gesture that causes a left to right user interface transition. In some embodiments, the user interface 215 is an AOD rendered by the first processor 225 that is in an active state of operation (shaded representation). While the first processor 225 is rendering the user interface 215, the second processor 227 is in an inactive mode of operation (unshaded representation). The first processor 225 analyzes the user input 210 and the presented user interface elements to predict satisfaction of one or more processor performance criteria for causing display of requested user interface 250. As shown in FIG. 2A, the first processor 225 predicts that the second processor 227 can satisfy the one or more processor performance criteria for causing display of the user interface 250, while the first processor 225 cannot. The one or more processor performance criteria can be analogous to those described above with respect to FIGS. 1A-1D. The first processor 225, in response to determining that performance of a request associated with the user input 210 would not satisfy the one or more processor performance criteria, sends a wake-up message 228 to the second processor 227.

FIG. 2B shows a second sequential user interface 250 rendered by the second processor 227 responsive to the user input 210 of FIG. 1A, in accordance with some embodiments. The user interface transition requiring the first processor 225 to hand-off display control to the second processor 227 can be associated with the user input 210 and the user interface elements corresponding an application for the requested user interface (e.g., messaging application 230).

In some embodiments, the second processor 227 completes the initialization and/or synchronization while the first processor 225 provides pre-rendered graphical elements, such as from a shared memory, for helping make the transition appear as seamless as possible. The pre-rendered graphical elements can be based on pixel-matching (and/or voxel matching) techniques to synchronize the transition from user interface 215 to user interface 250. After the first processor 225 hands-off display control to the second processor 227, the second processor 227 continues to operate in an active mode of operation (shaded representation) while the first processor 225 enters into an inactive mode of operation such as a sleep or stand-by mode of operation (unshaded representation).

FIG. 2C shows an example timing 200C representative of the user interface transition shown in FIGS. 2A and 2B, in accordance with some embodiments. At time (t0), the first processor 225 is in an active mode of operation and causes display of user interface 215. The second processor 227 is in an inactive mode of operation (e.g., stand-by mode, etc.) and continues to remain in the inactive mode until a wake-up message is received from the first processor 225. At time (t1), the first processor 225 detects user input 210 associated with the user interface 215 and determines that the user input 210 is a command operation requiring performance of one or more processor performance criteria that are not satisfied by the first processor. The first processor 225 determines that the command operation for one or more processor performance criteria are satisfied by the second processor 227. The first processor 225 then sends a wake-up message to the second processor 227 causing the second processor 227 to perform operations related to the one or more processor performance criteria. The second processor 227 then renders and causes display of the user interface 250 corresponding to the performance of the one or more processor performance criteria.

In some embodiments, after a predetermined period of time has elapsed, and no further user inputs are received in association with the user interface 250, the second processor 227 sends a wake-up message to the first processor 225 to revert display of the user device 105 back to a stand-by user interface, such as the AOD. The second processor 227 then transitions into an inactive mode of operation and the first processor 225 transitions into an active mode of operation and continues to monitor the AOD for any further user interactions.

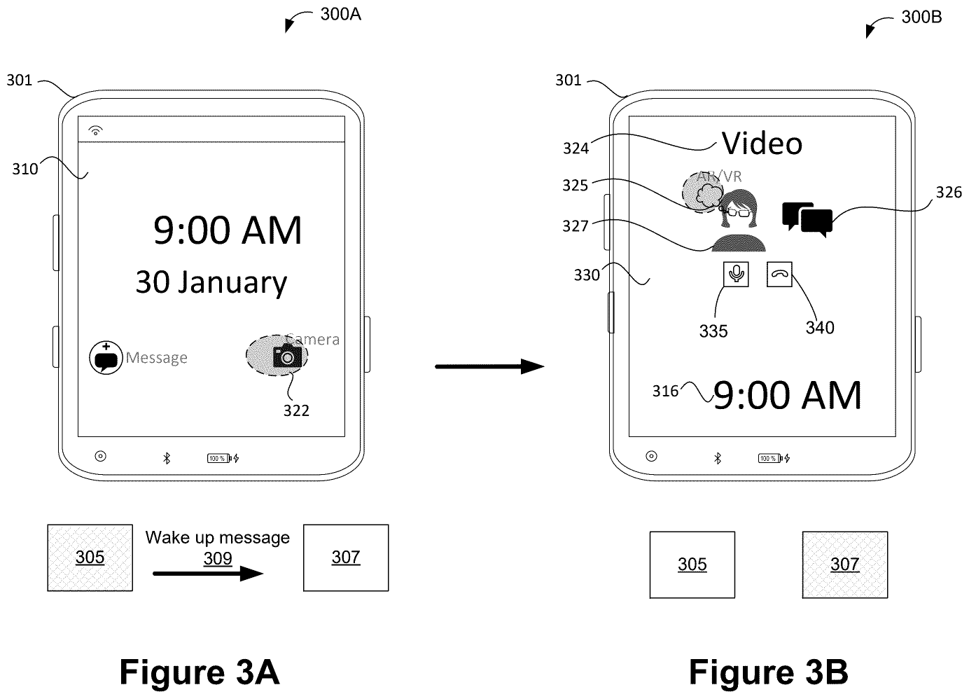

FIGS. 3A and 3B show a sequential user interface transition 300A and 300B from a first processor 305 to a second processor 307 based on a user input triggering particular hardware functionality, in accordance with some embodiments. For example, a user input 322 is a tap gesture selecting a camera icon via a touch input 322 associated with the user interface 310. Although user selection of a camera related application is shown, user selection could be related to any one of the selectable icons displayed via the user interface 310.

FIG. 3A shows an example of the user device 301 switching control of the user interface 310 from the first processor 305 to the second processor 307 based on the user input 322 and determining that the user input requests display of another user interface with functionality that cannot be met by the processor performance criteria of the first processor 305. Therefore, the first processor 305 that is an active mode of operation (shaded representation) sends a wake-up message 309 to the second processor 307 that is in an inactive mode of operation (unshaded representation).

In some embodiments, the first processor 305 can send further synchronization data and/or user interface layout coordination messages to the second processor 307 after sending the wake-up message 309. The synchronization and/or layout coordination messages can provide positional information for each of the rendered user interface elements for the user interface 310. Some of the rendered user interface elements can be pre-rendered elements provided by the second processor 307 as described above with respect to FIGS. 1A-2B.

FIG. 3B shows a sequential user interface 330 rendered by the second processor 307 after user interface control was handed-off by the first processor 305, in accordance with some embodiments. The second processor 307 is in an active state (shaded representation) in response to the wake-up message received from the first processor 305 as described in FIG. 3A. The second processor renders the user interface 330 to provide data intensive user interface elements and functionality such as live calls (335 and 330), optionality to connect to an AR/VR device 325, video messaging functionality 326, and other user interface elements (e.g., time 316, textual content 324, etc.).

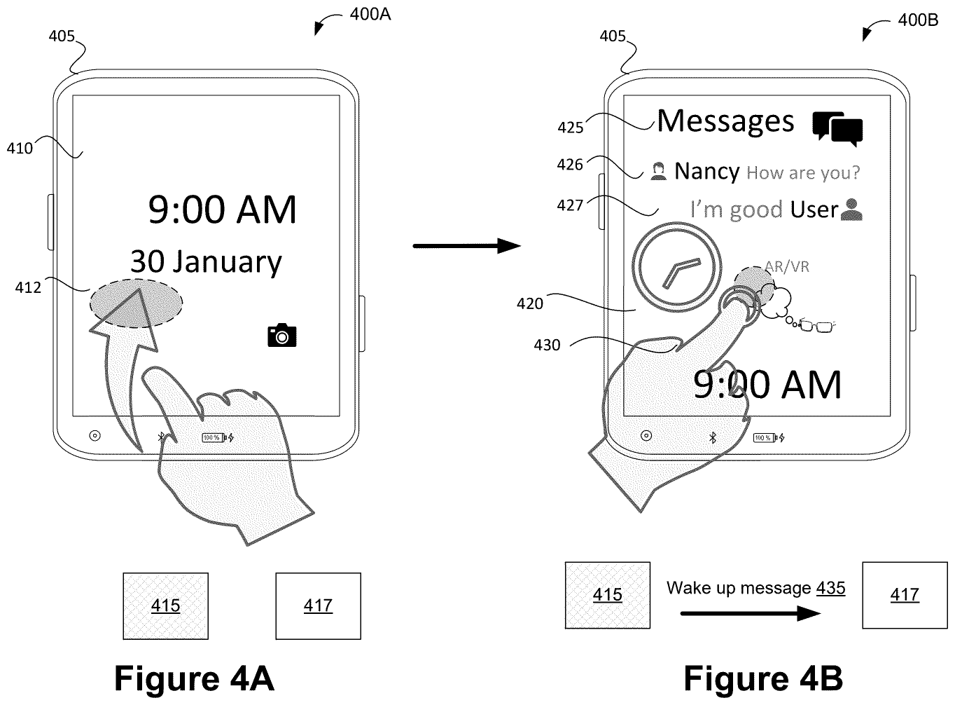

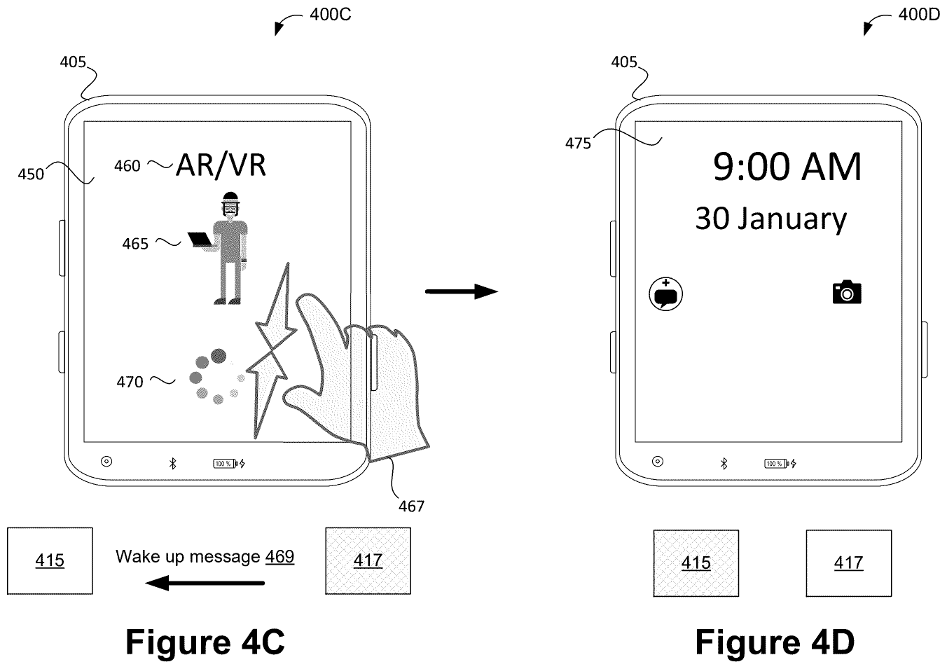

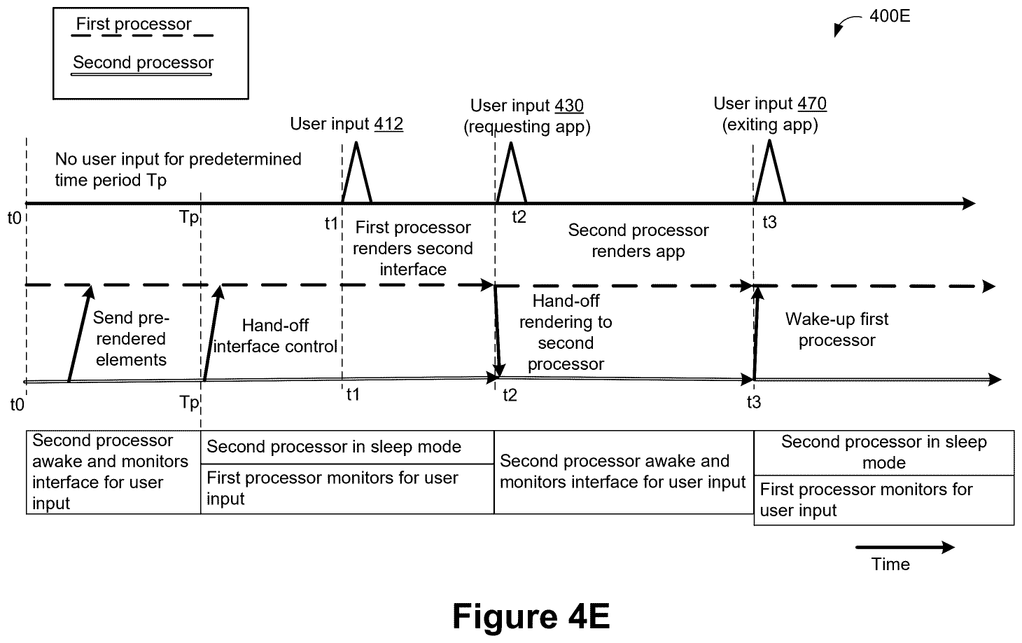

FIGS. 4A-4D show sequential user interface transitions 400A-400D, in accordance with some embodiments. For example, FIGS. 4A-4D show a first processor 415 causing display of two different user interfaces, then transitioning control over to a second processor 417 for providing user interface functionality for an application that requires processor performance criteria that are not satisfied by the first processor 415 but are satisfied by the second processor (e.g., high data transfer speeds, extensive hardware and memory logic, network interfaces for communication with external devices, etc.).

FIG. 4A shows an example illustration of a user interface 410 for user device 405 that receives a user input 412. In some embodiments, the user input 412 is a swipe up gesture for a user request to transition the user interface to a next user interface 420 of FIG. 4B. In accordance with some embodiments, the user interface 410 is provided by the first processor 415 (shaded representation). The user interface 410 can be an AOD. In some other embodiments, the user interface 410 can be a buried user interface that is triggered for display after the user device 405 receives at least two user inputs.

FIG. 4B shows a sequential second user interface 420 rendered by the first processor 415, in accordance with some embodiments. The second user interface receives a user input 430 for selecting an AR/VR based user application icon displayed by the user interface 420. Selection of the AR/VR application icon by the user input 430 triggers the first processor 415 to determine that the processor performance criteria for providing the AR/VR application functionality requires performance by the second processor 417. Therefore, first processor 415 sends a wake-up message 435 to the second processor 417 (the wake-up message functionality can be analogous to the wake-up messages described above with respect to FIGS. 1A-3B).

FIG. 4C shows user interface control that has transitioned over to the second processor 417 for providing AR/VR application functionality, in accordance with some embodiments. The second processor 417 is in an active mode of operation (shaded representation) for providing AR/VR functionality. The AR/VR functionality can be associated with an AR/VR application 460 and/or rendering of graphical representations of objects and/or people 465 related to the AR/VR application 460, via a user interface 450. While the second processor 417 is in the active mode of operation, the first processor 415 is in the inactive mode of operation (unshaded representation). In some embodiments, the second processor 417 detects a user input 470 that is related to a zoom out two-finger swipe via the user interface 450. The second processor 417 analyzes the user input 470 based on the currently displayed user interface elements and/or predicting corresponding user interface elements that can be rendered based on the type of user input received. In some embodiments, the second processor 417 then determines that the user input is indicative of a user's intent to exit the AR/VR application 460 and return to a home screen. The second processor 417 can further determine that the home screen user interface can be rendered by using the first processor 415. The second processor 417 then sends a wake-up message 469 to the first processor 415 to handle display of the home screen user interface 475.

FIG. 4D shows an example of a home screen user interface rendered by the first processor 415 after user interface control was handed-off by the second processor 417, in accordance with some embodiments. For example, the first processor 415 is in an active mode of operation (shaded representation) and the second processor 417 is in a stand-by mode of operation (unshaded representation) because the home screen user interface can be reliably rendered by the first processor 415 based on the processor performance criteria being met by the first processor 415.

FIG. 4E shows an example timing diagram associated with the user interface transitions of FIGS. 4A-4D, in accordance with some embodiments. For example, between time (t0) and time (Tp), the second processor is in an active mode of operation and renders one or more user interface elements for future use by the first processor. The second processor can send the pre-rendered user interface to the first processor and/or to a shared memory. If there is no user input for a predetermined time period (Tp), the second processor determines that the user device can conserve power by switching user interface control to the first processor. Thus, the second processor hands-off user interface control to the first processor after waiting for the predetermined time period (Tp). The first processor enters into an active mode of operation and monitors for any user inputs. Upon receiving user input 412, the first processor continues to handle user interface control and causes display of the second user interface as described above with respect to FIGS. 4A and 4B. Upon receiving a second user input 430, the first processor transitions user interface control to the second processor as described in FIGS. 4B and 4C.

The second processor takes over rendering of the user interface and monitors for any further user inputs. In some embodiments, upon receiving user input 470 indicating the user's intent to exit a currently rendered user application, the second processor sends the first processor a wake-up message to get ready to render a default home screen user interface. The second processor then hands-off user interface control to the first processor and enters into a low-power, sleep, hibernation, or Off state.

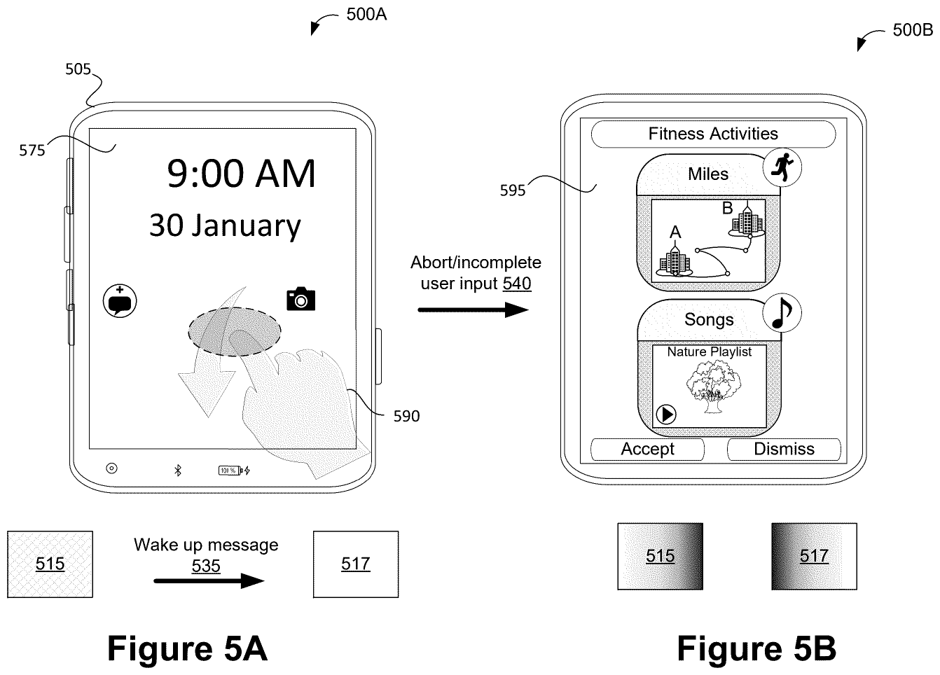

FIGS. 5A and 5B show an incomplete user input related to a user interface transition 500A and 500B, in accordance with some embodiments. For example, a first processor 515 detects a user input 590 associated with a user interface 575. The first processor 515 determines that the user input 590 is indicative of a user's intent to enable a highly interactive fitness application associated with another user interface 595. As described with respect to earlier FIGS. 1A-4B, the first processor sends a wake-up message to the second processor when processor performance criteria for the first processor are insufficient to render complete functionality of the requested user interface. In such cases, the first processor 515 can begin transitioning to an inactive mode of operation while the second processor 517 can begin transitioning to an active mode of operation, with or without further exchange of synchronization messaging between the two processors as described with respect to FIG. 5B below.

FIG. 5B shows the first processor 515 and the second processor 517 in mid-transition with respect to user interface control, in accordance with some embodiments. This is because, in some embodiments, in order to fully-transition to the user interface 595 and render functionality associated with the fitness application, the user input 590 needs to be a complete user input. For example, the user input 590 needs to be a swipe down gesture. If the user aborts the swipe down gesture before completion of the required gesture control (e.g., the user input is aborted mid-way, user input gesture is reversed, etc.), the first processor 515 receives data associated with the aborted user input 595. This causes the first processor 515 and second processor 517 to abort completion of the user interface transition and revert back to the previous user interface (e.g., user interface 575) that was being rendered by the first processor 515. The mid-transition phase of the first processor 515 and the second processor 517 can be based on partial display of user interface elements of the user interface 595 by the first processor 515 and/or the second processor 517. A proportion of the partially displayed user interface elements by both processors can be based on an amount of pre-rendered graphical elements provided by the second processor 517 and to the first processor 515 prior to the second processor 517 entering into the sleep mode.

While the examples provided above are described as performed at a smartphone, the different functions and/or operations described above with reference to FIGS. 1A-5B can be performed at any electronic device (e.g., a wrist-wearable device 1000, a head-wearable device, a server 930, a computer 940; and/or any other device described below in reference to FIGS. 9A and 9B) and/or combination of electronic devices. Additionally, visual representations of user intent can be generated for applications other than social media applications. For example, visual representations of user intent can be generated for messaging applications, web-browser applications, word-processing applications, and/or any other application that can run or be operated at an electronic device.

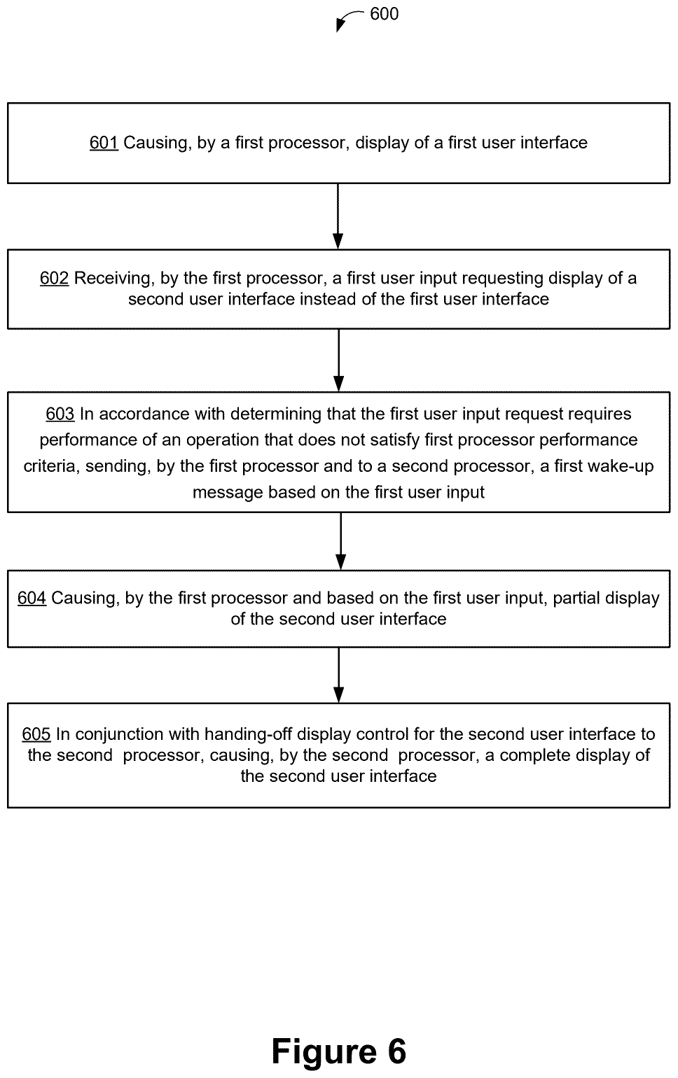

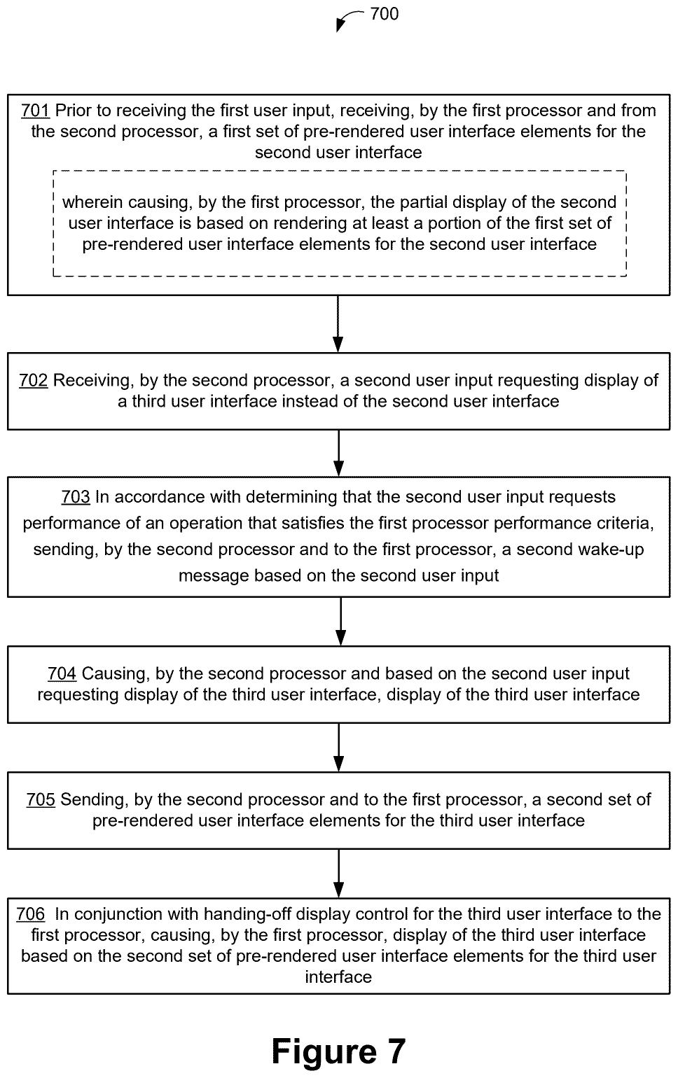

FIGS. 6 and 7 illustrate flow diagrams of methods 600 and 700, in accordance with some embodiments. Operations (e.g., steps) of the methods 600 and/or 700 can be performed by one or more processors (e.g., central processing unit and/or MCU) of a system (e.g., an AR device 1100, a VR device 1100, a wrist-wearable device 1000, and/or any other device described below in reference to FIG. 9A). At least some of the operations shown in FIGS. 1A-5B correspond to instructions stored in a computer memory or computer-readable storage medium (e.g., storage, RAM, and/or memory of an AR device 1100, a VR device 1100, a wrist-wearable device 1000, and/or any other device described below in reference to FIG. 9A). Operations of the methods 600 and/or 700 can be performed by a single device alone or in conjunction with one or more processors and/or hardware components of another communicatively coupled device (e.g., an AR device 1100, a VR device 1100, a wrist-wearable device 1000, and/or any other device described below in reference to FIG. 9A) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

The methods 600 and 700 occur at a user device (analogous to an AR device 1100, a VR device 1100, a wrist-wearable device 1000, and/or any other device described below in reference to FIG. 9A) with at least a first processor and a second processor.

(A1) In accordance with some embodiments, the method 600 includes a method of seamlessly switching UI control and display between a first processor and a second processor is provided. The method includes causing, by a first processor, display of a first user interface. The first processor receives a first user input requesting display of a second user interface instead of the first user interface. The first user input can be auditory, optical, physical touch, and/or EMG-based inputs (finger taps based on neuromuscular signals). In accordance with determining that the first user input request requires performance of an operation that does not satisfy processor performance criteria, sending, by the first processor and to a second processor, a first wake-up message based on the first user input. Before the wake-up message is sent, the second processor (e.g., SOC) can be operating in an inactive mode of operation (e.g., sleep state). The wake-up message can include information about the user's intent to swipe display of the user device from the first user interface to the second user interface. The method further includes causing, by the first processor and based on the first user input, partial display of the second user interface and in conjunction with handing-off display control for the second user interface to the second processor, causing, by the second processor, a complete display of the second user interface.

(A2) In some embodiments of A1, the first processor consumes lower operating power than the second processor.

(A3) In some embodiments of A1 or A2, first user interface is an AOD.

(A4) In some embodiments of any one of A1 to A3, causing, by the first processor and based on the first user input, the partial display of the second user interface is further based on a timestamp for the first wake-up message and a predetermined initialization time associated with the second processor.

(A5) In some embodiments of any one of A1 to A4, prior to receiving the first user input, the method includes receiving, by the first processor and from the second processor, a first set of pre-rendered user interface elements for the second user interface, wherein causing, by the first processor, the partial display of the second user interface is based on rendering at least a portion of the first set of pre-rendered user interface elements for the second user interface. In some embodiments, pre-rendered user interface elements can be bitmap images and/or other data associated with pre-coordinated layouts for each user interface. Pixel matching techniques can be used for generating the pre-rendered user interface elements.

(A6) In some embodiments of A5, the method further includes receiving, by the second processor, a second user input requesting display of a third user interface instead of the second user interface; and in accordance with determining that the second user input requests performance of an operation that satisfies the processor performance criteria, sending, by the second processor and to the first processor, a second wake-up message based on the second user input.

(A7) In some embodiments of A6, the method further includes causing, by the second processor and based on the second user input requesting display of the third user interface, display of the third user interface; sending, by the second processor and to the first processor, a second set of pre-rendered user interface elements for the third user interface; and in conjunction with handing-off display control for the third user interface to the first processor, causing, by the first processor, display of the third user interface based on the second set of pre-rendered user interface elements for the third user interface. In some embodiments, the first processor is configured only for partial display of the third user interface. In some embodiments, the processor is configured for complete display of the third user interface.

(A8) In some embodiments of A7, wherein sending, by the second processor and to the first processor, the second set of pre-rendered user interface elements for the third user interface is based on a timestamp associated with the second wake-up message and a predetermined initialization time for the first processor.

(A9) In some embodiments of A8, the method further includes receiving, by the first processor and from the second processor, a hand-off message for the third user interface; and causing, by the first processor and based on the hand-off message, the complete display of the third user interface.

(A10) In some embodiments of any one of A6 to A9, determining, by the second processor, that the second user input is an incomplete user input; and aborting sending of the second wake-up message to the first processor.

(A11) In some embodiments of any one of Al to A10, a single user device includes the first processor and the second processor. For example, the user device can be a smartwatch, or an AR/VR headset and the second user interface can be associated with a user interface element for enabling camera operation associated with the smartwatch or the AR/VR headset.

In some embodiments, the method 700 includes, (701) prior to receiving the first user input, receiving, by the first processor and from the second processor, a first set of pre-rendered user interface elements for the second user interface, wherein causing, by the first processor, the partial display of the second user interface is based on rendering at least a portion of the first set of pre-rendered user interface elements for the second user interface. The method further includes (702) receiving, by the second processor, a second user input requesting display of a third user interface instead of the second user interface, (703) in accordance with determining that the second user input requests performance of an operation that satisfies the processor performance criteria, sending, by the second processor and to the first processor, a second wake-up message based on the second user input, and (704) causing, by the second processor and based on the second user input requesting display of the third user interface, display of the third user interface. At (705) the second processor sends, to the first processor, a second set of pre-rendered user interface elements for the third user interface and at (706), in conjunction with handing-off display control for the third user interface to the first processor, the method includes causing, by the first processor, display of the third user interface based on the second set of pre-rendered user interface elements for the third user interface.

(B1) In accordance with some embodiments, a system comprising a first processor, a second processor communicatively coupled to the first processor, a first non-transitory memory coupled to the first processor, and a second non-transitory memory coupled to the second processor is provided. The first non-transitory memory storing one or more programs to be executed by the first processor, the one or more programs including instructions for causing display of a first user interface; receiving a first user input for the first user interface, wherein the first user input requests display of a second user interface instead of the first user interface; in accordance with determining that the first user input request requires performance of an operation that does not satisfy processor performance criteria, sending, by the first processor and to the second processor, a first wake-up message based on the first user input; and causing, based on the first user input, partial display of the second user interface. The second non-transitory memory storing one or more programs to be executed by the second processor, the one or more programs including instructions for receiving the first wake-up message; and causing a complete display of the second user interface.

In some embodiments, the system can be configured to perform any one of A2-A11.

(C1) In accordance with some embodiments, a first non-transitory computer-readable storage medium and a second non-transitory computer-readable storage medium is provided. The first and the second non-transitory computer-readable storage mediums includes instructions that, when executed by a wearable user device, cause the wearable device to perform or cause performance of the method of any of A1-A11.

(D1) In accordance with some embodiments, a method of operating an artificial reality headset, including operations that correspond to any of A1-A11.

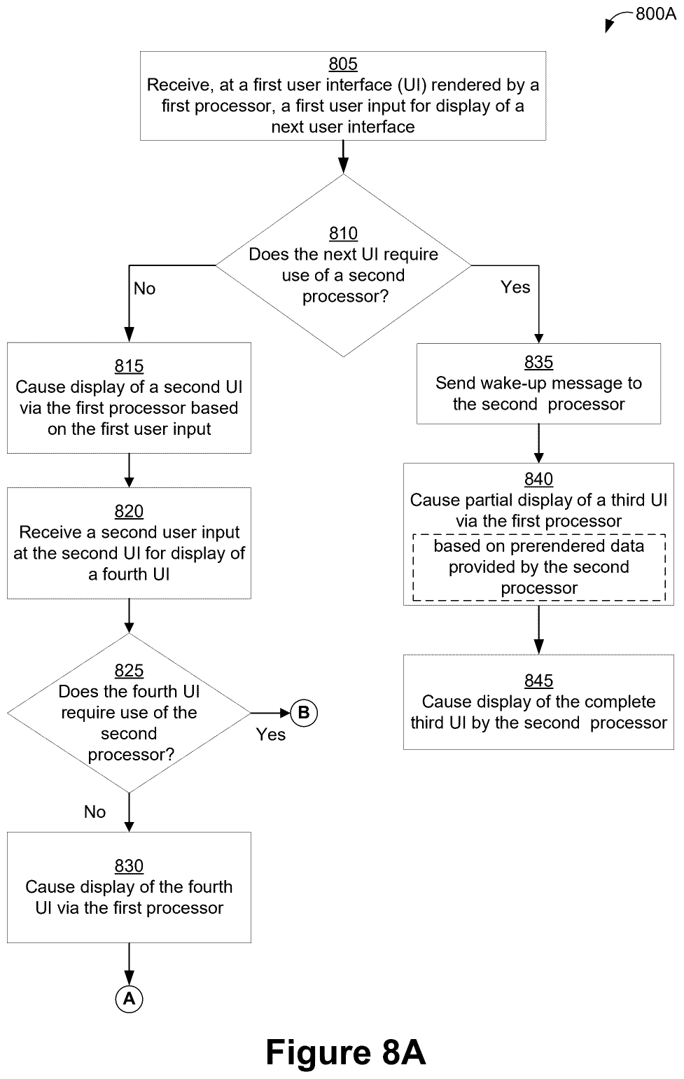

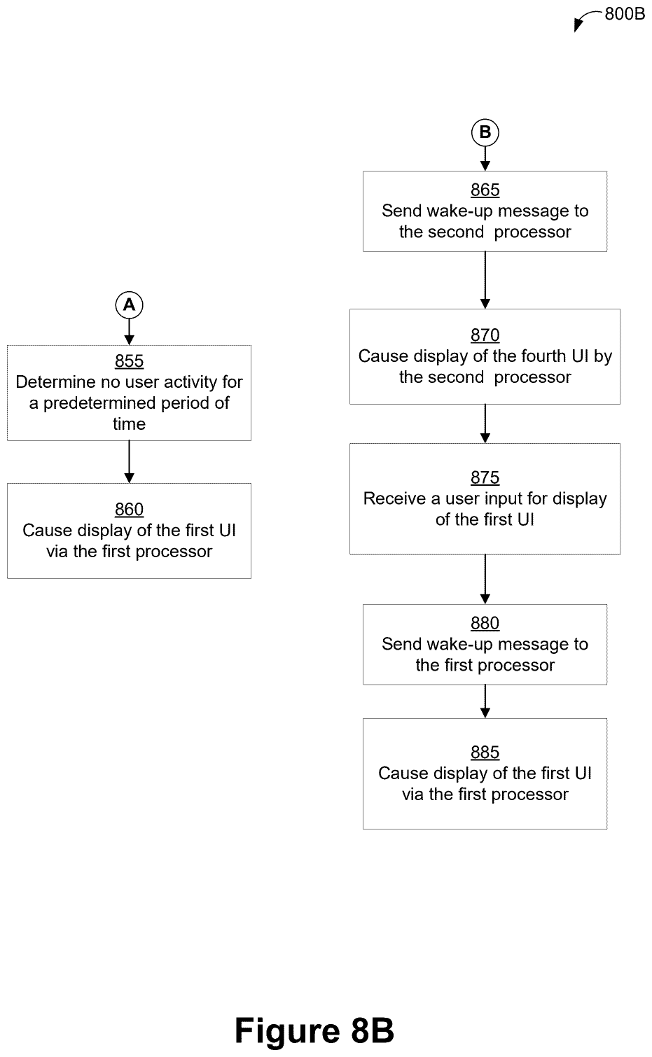

FIGS. 8A and 8B show example flow charts 800A and 800B for seamless user interface transitions between a first processor and a second processor of a user device. At step 805, the first processor receives, at a first user interface rendered by the first processor, a first user input for display for a next user interface. At step 810, the first processor determines whether the next user interface requires use of the second processor. If the next user interface requires processor performance criteria that can be met by the second processor, but cannot be met by the first processor (Yes at step 810) the system proceeds to Step 835. If the next user interface requires processor performance criteria that can be met by the first processor and the second processor is not needed (No at step 810) the system proceeds to Step 815.

At step 815, the system causes display of the second user interface via the first processor and based on the first user input. For example, the first processor continues to control the user interfaces as the first user interface transitions to the second user interface. At step 835, the first processor sends the second processor a wake-up message. In some embodiments, subsequent to sending the wake-up message, the first processor begins to transition into a sleep mode or inactive mode of operation as the second processor transitions into an active mode of operation.

At step 840, the system causes partial display of a third user interface that is rendered by the first processor. In some embodiments, the first processor renders the partial third user interface based on pre-rendered data provided by the second processor. For example, the pre-rendered data can be pre-coordinated and synchronized user interface elements for the third user interface.

At step 845, the system causes display of a complete third user interface. For example, the second processor is in an active state and renders the complete third user interface while the first processor is in an inactive state.

At step 820, the first processor receives a second user input associated with the second user interface requesting display of a fourth user interface. At step 825, the first processor determines whether the fourth user interface requires use of the second processor. If the fourth user interface does not require rendering by the second processor because the processor performance criteria are satisfied by the first processor (No at step 825), the system proceeds to step 830 and causes display of the fourth user interface by the first processor.

If the fourth user interface requires rendering by the second processor because the processor performance criteria are not satisfied by the first processor (Yes at step 825), the system proceeds to step 865 of FIG. 8B.

At step 865, the first processor sends the second processor a wake-up message. In some embodiments, subsequent to the wake-up message, the first processor enters into an inactive mode of operation and the second processor enters into an active mode of operation.

At step 870, the second processor causes display of the fourth user interface. In some embodiments, the second processor monitors the fourth user interface for user inputs. At step 875, the second processor receives a user input requesting display of the first user interface.

At step 880, the second processor sends a wake-up message to the first processor. In some embodiments, the wake-up message is sent subsequent to receiving the user input requesting display of the first user interface.

At step 885, the first processor is in an active state and causes display of the first user input. In some embodiments, the first processor enters the active state of operation in response to the wake-up message sent by the second processor.

At step 855, the first processor determines that there has been no user activity a predetermined period of time associated with display of the fourth user interface. At step 860, the first processor causes display of the first user interface. In some embodiments, the first processor causes user interfaces to seamlessly transition from the fourth user interface to the first user interface, such as an AOD.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 1000, a head-wearable device, or other computer system). There are distinct types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems (9A-9C-2)

FIGS. 9A, 9B, 9C-1, and 9C-2 illustrate example artificial-reality systems, in accordance with some embodiments. FIG. 9A shows a first AR system 900a and first example user interactions using a wrist-wearable device 1000, and/or a head-wearable device (e.g., AR device 1100). FIG. 9B shows a second AR system 900b and second example user interactions using a wrist-wearable device 1000, and/or an AR device 1100. FIGS. 9C-1 and 9C-2 show a third AR system 900c and third example user interactions using a wrist-wearable device 1000 and/or a head-wearable device (e.g., virtual-reality (VR) device 1110). As the skilled artisan will appreciate upon reading the descriptions provided herein, the above-example AR systems (described in detail below) can perform various functions and/or operations described above with reference to FIGS. 1A-8B.

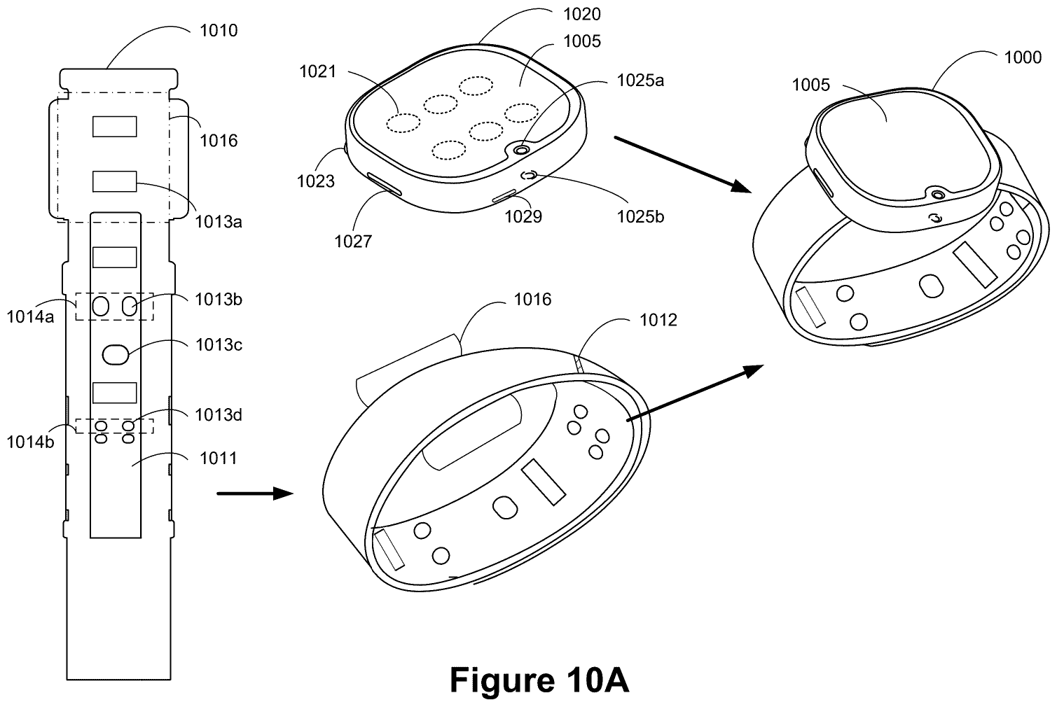

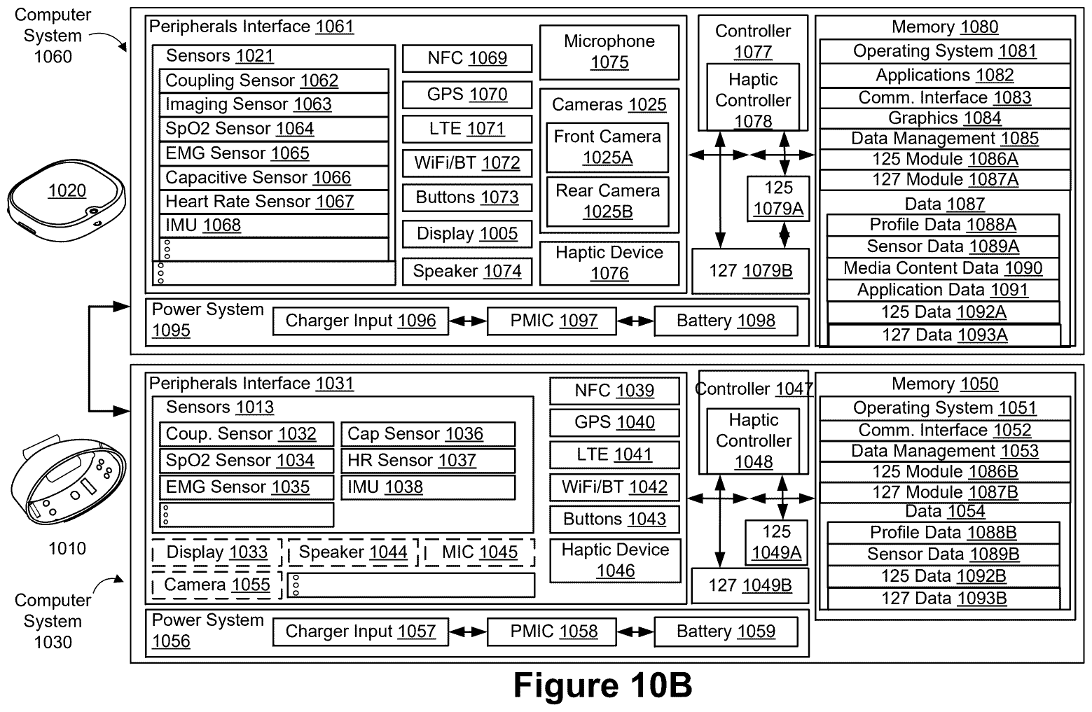

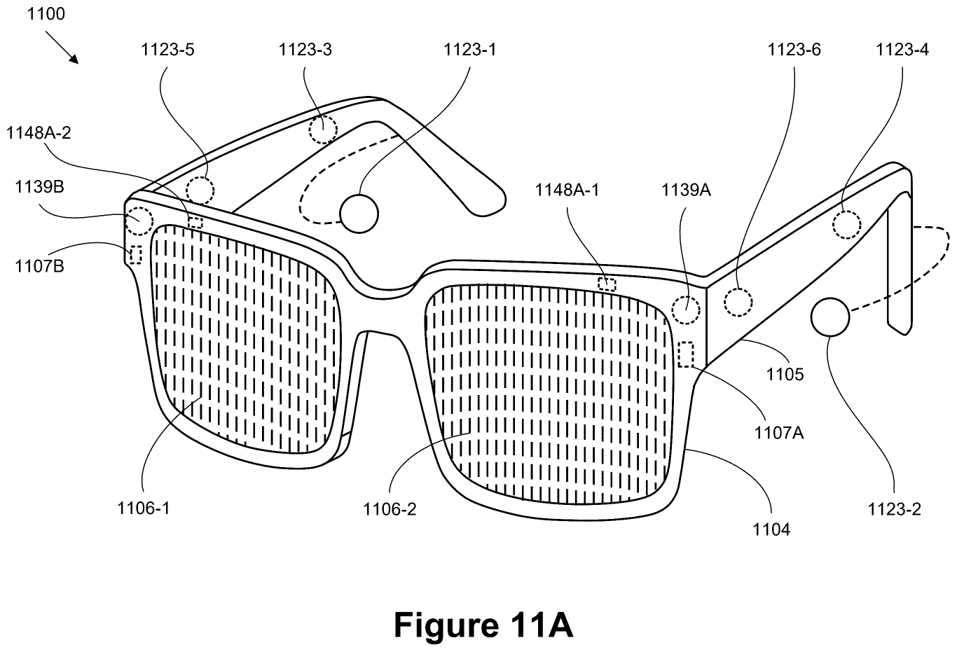

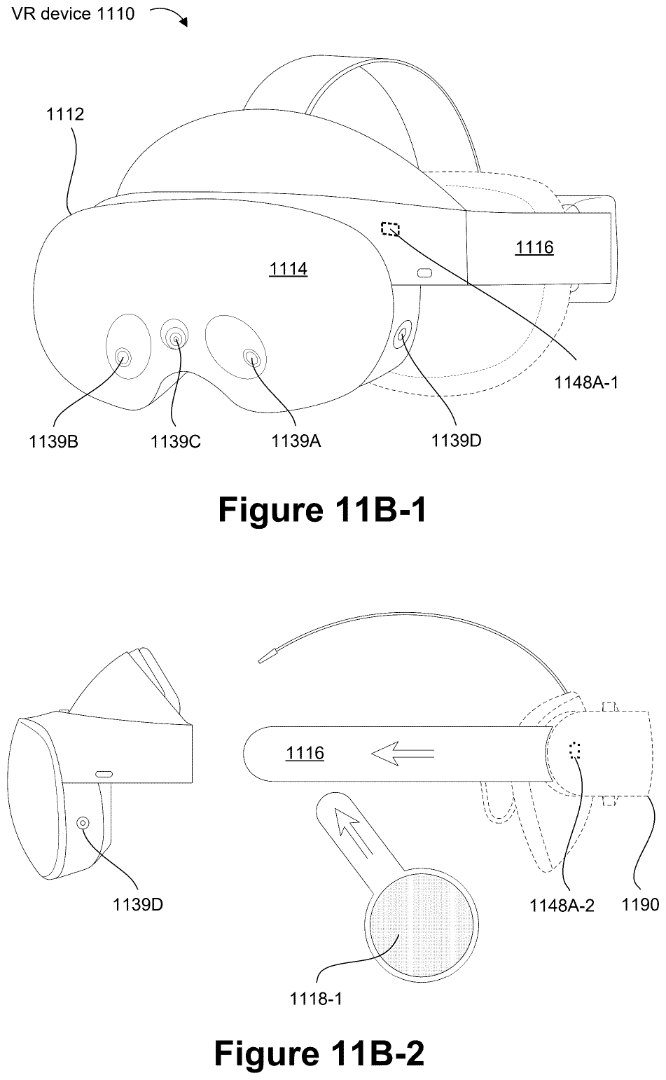

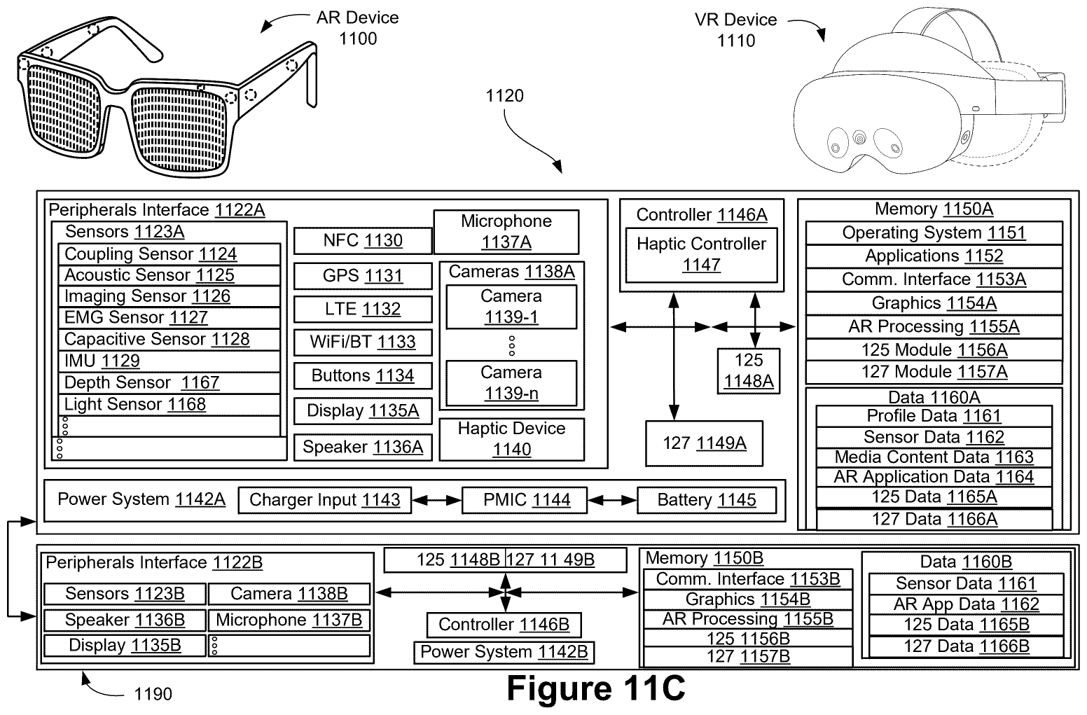

The wrist-wearable device 1000 and its constituent components are described below in reference to FIGS. 10A-10B, the head-wearable devices and their constituent components are described below in reference to FIGS. 11A-11D. The wrist-wearable device 1000 and/or the head-wearable devices can communicatively couple via a network 925 (e.g., cellular, near field, Wi-Fi, personal area network, wireless LAN, etc.). Additionally, the wrist-wearable device 1000 and/or the head-wearable devices can also communicatively couple with one or more servers 930, computers 940 (e.g., laptops, computers, etc.), mobile devices 950 (e.g., smartphones, tablets, etc.), and/or other electronic devices via the network 925 (e.g., cellular, near field, Wi-Fi, personal area network, wireless LAN, etc.)

Turning to FIG. 9A, a user 902 is shown wearing the wrist-wearable device 1000 and the AR device 1100. The wrist-wearable device 1000 and the AR device 1100 facilitate user interaction with an AR environment. In particular, as shown by the first AR system 900a, the wrist-wearable device 1000, and/or the AR device 1100 cause presentation of one or more avatars 904, digital representations of contacts 906, and virtual objects 908. As discussed below, the user 902 can interact with the one or more avatars 904, digital representations of the contacts 906, and virtual objects 908 via the wrist-wearable device 1000, and/or the AR device 1100

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a distinct set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 10A and 10B illustrate an example wrist-wearable device 1000, in accordance with some embodiments. The wrist-wearable device 1000 is an instance of the user device 105, 205, 301, 405, or 505 described in reference to FIGS. 1A-5B herein, such that the wrist-wearable devices should be understood to have the features of the wrist-wearable device 1000 and vice versa. FIG. 10A illustrates components of the wrist-wearable device 1000, which can be used individually or in combination, including combinations that include other electronic devices and/or electronic components.

FIG. 10A shows a wearable band 1010 and a watch body 1020 (or capsule) being coupled, as discussed below, to form the wrist-wearable device 1000. The wrist-wearable device 1000 can perform various functions and/or operations associated with navigating through user interfaces and selectively opening applications, as well as the functions and/or operations described above with reference to FIGS. 1A-8B.

As will be described in more detail below, operations executed by the wrist-wearable device 1000 can include (i) presenting content to a user (e.g., displaying visual content via a display 1005); (ii) detecting (e.g., sensing) user input (e.g., sensing a touch on peripheral button 1023 and/or at a touch screen of the display 1005, a hand gesture detected by sensors (e.g., biopotential sensors)); (iii) sensing biometric data via one or more sensors 1013 (e.g., neuromuscular signals, heart rate, temperature, sleep, etc.); messaging (e.g., text, speech, video, etc.); image capture via one or more imaging devices or cameras 1025; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 1020, independently in the wearable band 1010, and/or via an electronic communication between the watch body 1020 and the wearable band 1010. In some embodiments, functions can be executed on the wrist-wearable device 1000 while an AR environment is being presented (e.g., via one of the AR systems 900a to 900d). As the skilled artisan will appreciate upon reading the descriptions provided herein, the novel wearable devices described herein can be used with other types of AR environments.

The wearable band 1010 can be configured to be worn by a user such that an inner (or inside) surface of the wearable structure 1011 of the wearable band 1010 is in contact with the user's skin. When worn by a user, sensors 1013 contact the user's skin. The sensors 1013 can sense biometric data such as a user's heart rate, saturated oxygen level, temperature, sweat level, neuromuscular signal sensors, or a combination thereof. The sensors 1013 can also sense data about a user's environment, including a user's motion, altitude, location, orientation, gait, acceleration, position, or a combination thereof. In some embodiments, the sensors 1013 are configured to track a position and/or motion of the wearable band 1010. The one or more sensors 1013 can include any of the sensors defined above and/or discussed below with respect to FIG. 10B.

The one or more sensors 1013 can be distributed on an inside and/or an outside surface of the wearable band 1010. In some embodiments, the one or more sensors 1013 are uniformly spaced along the wearable band 1010. Alternatively, in some embodiments, the one or more sensors 1013 are positioned at distinct points along the wearable band 1010. As shown in FIG. 10A, the one or more sensors 1013 can be the same or distinct. For example, in some embodiments, the one or more sensors 1013 can be shaped as a pill (e.g., sensor 1013a), an oval, a circle a square, an oblong (e.g., sensor 1013c) and/or any other shape that maintains contact with the user's skin (e.g., such that neuromuscular signal and/or other biometric data can be accurately measured at the user's skin). In some embodiments, the one or more sensors 1013 are aligned to form pairs of sensors (e.g., for sensing neuromuscular signals based on differential sensing within each respective sensor). For example, sensor 1013b is aligned with an adjacent sensor to form sensor pair 1014a and sensor 1013d is aligned with an adjacent sensor to form sensor pair 1014b. In some embodiments, the wearable band 1010 does not have a sensor pair. Alternatively, in some embodiments, the wearable band 1010 has a predetermined number of sensor pairs (one pair of sensors, three pairs of sensors, four pairs of sensors, six pairs of sensors, sixteen pairs of sensors, etc.).

The wearable band 1010 can include any suitable number of sensors 1013. In some embodiments, the number, and arrangements of sensors 1013 depend on the particular application for which the wearable band 1010 is used. For instance, a wearable band 1010 configured as an armband, wristband, or chest-band may include a plurality of sensors 1013 with different number of sensors 1013 and different arrangement for each use case, such as medical use cases, compared to gaming or general day-to-day use cases.

In accordance with some embodiments, the wearable band 1010 further includes an electrical ground electrode and a shielding electrode. The electrical ground and shielding electrodes, like the sensors 1013, can be distributed on the inside surface of the wearable band 1010 such that they contact a portion of the user's skin. For example, the electrical ground and shielding electrodes can be at an inside surface of coupling mechanism 1016 or an inside surface of a wearable structure 1011. The electrical ground and shielding electrodes can be formed and/or use the same components as the sensors 1013. In some embodiments, the wearable band 1010 includes more than one electrical ground electrode and more than one shielding electrode.

The sensors 1013 can be formed as part of the wearable structure 1011 of the wearable band 1010. In some embodiments, the sensors 1013 are flush or substantially flush with the wearable structure 1011 such that they do not extend beyond the surface of the wearable structure 1011. While flush with the wearable structure 1011, the sensors 1013 are still configured to contact the user's skin (e.g., via a skin-contacting surface). Alternatively, in some embodiments, the sensors 1013 extend beyond the wearable structure 1011 a predetermined distance (e.g., 0.1 mm to 2 mm) to make contact and depress into the user's skin. In some embodiments, the sensors 1013 are coupled to an actuator (not shown) configured to adjust an extension height (e.g., a distance from the surface of the wearable structure 1011) of the sensors 1013 such that the sensors 1013 make contact and depress into the user's skin. In some embodiments, the actuators adjust the extension height between 0.01 mm to 1.2 mm. This allows the user to customize the positioning of the sensors 1013 to improve the overall comfort of the wearable band 1010 when worn while still allowing the sensors 1013 to contact the user's skin. In some embodiments, the sensors 1013 are indistinguishable from the wearable structure 1011 when worn by the user.

The wearable structure 1011 can be formed of an elastic material, elastomers, etc., configured to be stretched and fitted to be worn by the user. In some embodiments, the wearable structure 1011 is a textile or woven fabric. As described above, the sensors 1013 can be formed as part of a wearable structure 1011. For example, the sensors 1013 can be molded into the wearable structure 1011 or be integrated into a woven fabric (e.g., the sensors 1013 can be sewn into the fabric and mimic the pliability of fabric (e.g., the sensors 1013 can be constructed from a series of woven strands of fabric)).

The wearable structure 1011 can include flexible electronic connectors that interconnect the sensors 1013, the electronic circuitry, and/or other electronic components (described below in reference to FIG. 10B) that are enclosed in the wearable band 1010. In some embodiments, the flexible electronic connectors are configured to interconnect the sensors 1013, the electronic circuitry, and/or other electronic components of the wearable band 1010 with respective sensors and/or other electronic components of another electronic device (e.g., watch body 1020). The flexible electronic connectors are configured to move with the wearable structure 1011 such that the user adjustment to the wearable structure 1011 (e.g., resizing, pulling, folding, etc.) does not stress or strain the electrical coupling of components of the wearable band 1010.

As described above, the wearable band 1010 is configured to be worn by a user. In particular, the wearable band 1010 can be shaped or otherwise manipulated to be worn by a user. For example, the wearable band 1010 can be shaped to have a substantially circular shape such that it can be configured to be worn on the user's lower arm or wrist. Alternatively, the wearable band 1010 can be shaped to be worn on another body part of the user, such as the user's upper arm (e.g., around a bicep), forearm, chest, legs, etc. The wearable band 1010 can include a retaining mechanism 1012 (e.g., a buckle, a hook and loop fastener, etc.) for securing the wearable band 1010 to the user's wrist or other body part. While the wearable band 1010 is worn by the user, the sensors 1013 sense data (referred to as sensor data) from the user's skin. In particular, the sensors 1013 of the wearable band 1010 obtain (e.g., sense and record) neuromuscular signals.

The sensed data (e.g., sensed neuromuscular signals) can be used to detect and/or determine the user's intention to perform certain motor actions. In particular, the sensors 1013 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1005 of the wrist-wearable device 1000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1013 can be used to provide a user with an enhanced interaction with a physical object (e.g., devices communicatively coupled with the wearable band 1010) and/or a virtual object in an artificial-reality application generated by an artificial-reality system (e.g., user interface objects presented on the display 1005 or another computing device (e.g., a smartphone)).

In some embodiments, the wearable band 1010 includes one or more haptic devices 1046 (FIG. 10B; e.g., a vibratory haptic actuator) that are configured to provide haptic feedback (e.g., a cutaneous and/or kinesthetic sensation, etc.) to the user's skin. The sensors 1013, and/or the haptic devices 1046 can be configured to operate in conjunction with multiple applications including, without limitation, health monitoring, social media, games, and artificial reality (e.g., the applications associated with artificial reality).

The wearable band 1010 can also include coupling mechanism 1016 (e.g., a cradle or a shape of the coupling mechanism can correspond to shape of the watch body 1020 of the wrist-wearable device 1000) for detachably coupling a capsule (e.g., a computing unit) or watch body 1020 (via a coupling surface of the watch body 1020) to the wearable band 1010. In particular, the coupling mechanism 1016 can be configured to receive a coupling surface proximate to the bottom side of the watch body 1020 (e.g., a side opposite to a front side of the watch body 1020 where the display 1005 is located), such that a user can push the watch body 1020 downward into the coupling mechanism 1016 to attach the watch body 1020 to the coupling mechanism 1016. In some embodiments, the coupling mechanism 1016 can be configured to receive a top side of the watch body 1020 (e.g., a side proximate to the front side of the watch body 1020 where the display 1005 is located) that is pushed upward into the cradle, as opposed to being pushed downward into the coupling mechanism 1016. In some embodiments, the coupling mechanism 1016 is an integrated component of the wearable band 1010 such that the wearable band 1010 and the coupling mechanism 1016 are a single unitary structure. In some embodiments, the coupling mechanism 1016 is a type of frame or shell that allows the watch body 1020 coupling surface to be retained within or on the wearable band 1010 coupling mechanism 1016 (e.g., a cradle, a tracker band, a support base, a clasp, etc.).

The coupling mechanism 1016 can allow for the watch body 1020 to be detachably coupled to the wearable band 1010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1020 to the wearable band 1010 and to decouple the watch body 1020 from the wearable band 1010. For example, a user can twist, slide, turn, push, pull, or rotate the watch body 1020 relative to the wearable band 1010, or a combination thereof, to attach the watch body 1020 to the wearable band 1010 and to detach the watch body 1020 from the wearable band 1010. Alternatively, as discussed below, in some embodiments, the watch body 1020 can be decoupled from the wearable band 1010 by actuation of the release mechanism 1029.

The wearable band 1010 can be coupled with a watch body 1020 to increase the functionality of the wearable band 1010 (e.g., converting the wearable band 1010 into a wrist-wearable device 1000, adding an additional computing unit and/or battery to increase computational resources and/or a battery life of the wearable band 1010, adding additional sensors to improve sensed data, etc.). As described above, the wearable band 1010 (and the coupling mechanism 1016) is configured to operate independently (e.g., execute functions independently) from watch body 1020. For example, the coupling mechanism 1016 can include one or more sensors 1013 that contact a user's skin when the wearable band 1010 is worn by the user and provide sensor data for determining control commands.

A user can detach the watch body 1020 (or capsule) from the wearable band 1010 in order to reduce the encumbrance of the wrist-wearable device 1000 to the user. For embodiments in which the watch body 1020 is removable, the watch body 1020 can be referred to as a removable structure, such that in these embodiments the wrist-wearable device 1000 includes a wearable portion (e.g., the wearable band 1010) and a removable structure (the watch body 1020).

Turning to the watch body 1020, the watch body 1020 can have a substantially rectangular or circular shape. The watch body 1020 is configured to be worn by the user on their wrist or on another body part. More specifically, the watch body 1020 is sized to be easily carried by the user, attached on a portion of the user's clothing, and/or coupled to the wearable band 1010 (forming the wrist-wearable device 1000). As described above, the watch body 1020 can have a shape corresponding to the coupling mechanism 1016 of the wearable band 1010. In some embodiments, the watch body 1020 includes a single release mechanism 1029 or multiple release mechanisms (e.g., two release mechanisms 1029 positioned on opposing sides of the watch body 1020, such as spring-loaded buttons) for decoupling the watch body 1020 and the wearable band 1010. The release mechanism 1029 can include, without limitation, a button, a knob, a plunger, a handle, a lever, a fastener, a clasp, a dial, a latch, or a combination thereof.

A user can actuate the release mechanism 1029 by pushing, turning, lifting, depressing, shifting, or performing other actions on the release mechanism 1029. Actuation of the release mechanism 1029 can release (e.g., decouple) the watch body 1020 from the coupling mechanism 1016 of the wearable band 1010, allowing the user to use the watch body 1020 independently from wearable band 1010, and vice versa. For example, decoupling the watch body 1020 from the wearable band 1010 can allow the user to capture images using rear-facing camera 1025B. Although the coupling mechanism 1016 is shown positioned at a corner of watch body 1020, the release mechanism 1029 can be positioned anywhere on watch body 1020 that is convenient for the user to actuate. In addition, in some embodiments, the wearable band 1010 can also include a respective release mechanism for decoupling the watch body 1020 from the coupling mechanism 1016. In some embodiments, the release mechanism 1029 is optional and the watch body 1020 can be decoupled from the coupling mechanism 1016 as described above (e.g., via twisting, rotating, etc.).

The watch body 1020 can include one or more peripheral buttons 1023 and 1027 for performing various operations at the watch body 1020. For example, the peripheral buttons 1023 and 1027 can be used to turn on or wake (e.g., transition from a sleep state to an active state) the display 1005, unlock the watch body 1020, increase or decrease a volume, increase, or decrease brightness, interact with one or more applications, interact with one or more user interfaces, etc. Additionally, or alternatively, in some embodiments, the display 1005 operates as a touch screen and allows the user to provide one or more inputs for interacting with the watch body 1020.

In some embodiments, the watch body 1020 includes one or more sensors 1021. The sensors 1021 of the watch body 1020 can be the same or distinct from the sensors 1013 of the wearable band 1010. The sensors 1021 of the watch body 1020 can be distributed on an inside and/or an outside surface of the watch body 1020. In some embodiments, the sensors 1021 are configured to contact a user's skin when the watch body 1020 is worn by the user. For example, the sensors 1021 can be placed on the bottom side of the watch body 1020 and the coupling mechanism 1016 can be a cradle with an opening that allows the bottom side of the watch body 1020 to directly contact the user's skin. Alternatively, in some embodiments, the watch body 1020 does not include sensors that are configured to contact the user's skin (e.g., including sensors internal and/or external to the watch body 1020 that configured to sense data of the watch body 1020 and the watch body 1020′s surrounding environment). In some embodiments, the sensors 1013 are configured to track a position and/or motion of the watch body 1020.

The watch body 1020 and the wearable band 1010 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 1020 and the wearable band 1010 can share data sensed by the sensors 1013 and 1021, as well as application-and device-specific information (e.g., active and/or available applications), output devices (e.g., display, speakers, etc.), input devices (e.g., touch screen, microphone, imaging sensors, etc.).

In some embodiments, the watch body 1020 can include, without limitation, a front-facing camera 1025A and/or a rear-facing camera 1025B, sensors 1021 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1063; FIG. 10B), a touch sensor, a sweat sensor, etc.). In some embodiments, the watch body 1020 can include one or more haptic devices 1076 (FIG. 10B; a vibratory haptic actuator) that is configured to provide haptic feedback (e.g., a cutaneous and/or kinesthetic sensation, etc.) to the user. The sensors 1021 and/or the haptic device 1076 can also be configured to operate in conjunction with multiple applications including, without limitation, health-monitoring applications, social media applications, game applications, and artificial-reality applications (e.g., the applications associated with artificial reality).

As described above, the watch body 1020 and the wearable band 1010, when coupled, can form the wrist-wearable device 1000. When coupled, the watch body 1020 and wearable band 1010 operate as a single device to execute functions (operations, detections, communications, etc.) described herein. In some embodiments, each device is provided with particular instructions for performing the one or more operations of the wrist-wearable device 1000. For example, in accordance with a determination that the watch body 1020 does not include neuromuscular signal sensors, the wearable band 1010 can include alternative instructions for performing associated instructions (e.g., providing sensed neuromuscular signal data to the watch body 1020 via a different electronic device). Operations of the wrist-wearable device 1000 can be performed by the watch body 1020 alone or in conjunction with the wearable band 1010 (e.g., via respective processors and/or hardware components) and vice versa. In some embodiments, operations of the wrist-wearable device 1000, the watch body 1020, and/or the wearable band 1010 can be performed in conjunction with one or more processors and/or hardware components of another communicatively coupled device.

As described below with reference to the block diagram of FIG. 10B, the wearable band 1010 and/or the watch body 1020 can each include independent resources required to independently execute functions. For example, the wearable band 1010 and/or the watch body 1020 can each include a power source (e.g., a battery), a memory, data storage, a processor (e.g., a central processing unit (CPU)), communications, a light source, and/or input/output devices.

FIG. 10B shows block diagrams of a computing system 1030 corresponding to the wearable band 1010, and a computing system 1060 corresponding to the watch body 1020, according to some embodiments. A computing system of the wrist-wearable device 1000 includes a combination of components of the wearable band computing system 1030 and the watch body computing system 1060, in accordance with some embodiments.

The watch body 1020 and/or the wearable band 1010 can include one or more components shown in watch body computing system 1060. In some embodiments, a single integrated circuit includes all or a substantial portion of the components of the watch body computing system 1060 are included in a single integrated circuit. Alternatively, in some embodiments, components of the watch body computing system 1060 are included in a plurality of integrated circuits that are communicatively coupled. In some embodiments, the watch body computing system 1060 is configured to couple (e.g., via a wired or wireless connection) with the wearable band computing system 1030, which allows the computing systems to share components, distribute tasks, and/or perform other operations described herein (individually or as a single device).

The watch body computing system 1060 can include one or more processors 1079, a controller 1077, a peripherals interface 1061, a power system 1095, and memory (e.g., a memory 1080), each of which are defined above and described in more detail below.

The power system 1095 can include a charger input 1096, a power-management integrated circuit (PMIC) 1097, and a battery 1098, each are which are defined above. In some embodiments, a watch body 1020 and a wearable band 1010 can have respective charger inputs (e.g., charger input 1096 and 1057), respective batteries (e.g., battery 1098 and 1059), and can share power with each other (e.g., the watch body 1020 can power and/or charge the wearable band 1010, and vice versa). Although watch body 1020 and/or the wearable band 1010 can include respective charger inputs, a single charger input can charge both devices when coupled. The watch body 1020 and the wearable band 1010 can receive a charge using a variety of techniques. In some embodiments, the watch body 1020 and the wearable band 1010 can use a wired charging assembly (e.g., power cords) to receive the charge. Alternatively, or in addition, the watch body 1020 and/or the wearable band 1010 can be configured for wireless charging. For example, a portable charging device can be designed to mate with a portion of watch body 1020 and/or wearable band 1010 and wirelessly deliver usable power to a battery of watch body 1020 and/or wearable band 1010. The watch body 1020 and the wearable band 1010 can have independent power systems (e.g., power system 1095 and 1056) to enable each to operate independently. The watch body 1020 and wearable band 1010 can also share power (e.g., one can charge the other) via respective PMICs (e.g., PMICs 1097 and 1058) that can share power over power and ground conductors and/or over wireless charging antennas.

In some embodiments, the peripherals interface 1061 can include one or more sensors 1021, many of which listed below are defined above. The sensors 1021 can include one or more coupling sensors 1062 for detecting when the watch body 1020 is coupled with another electronic device (e.g., a wearable band 1010). The sensors 1021 can include imaging sensors 1063 (one or more of the cameras 1025 and/or separate imaging sensors 1063 (e.g., thermal-imaging sensors)). In some embodiments, the sensors 1021 include one or more SpO2 sensors 1064. In some embodiments, the sensors 1021 include one or more biopotential-signal sensors (e.g., EMG sensors 1065, which may be disposed on a user-facing portion of the watch body 1020 and/or the wearable band 1010). In some embodiments, the sensors 1021 include one or more capacitive sensors 1066. In some embodiments, the sensors 1021 include one or more heart rate sensors 1067. In some embodiments, the sensors 1021 include one or more IMUs 1068. In some embodiments, one or more IMUs 1068 can be configured to detect movement of a user's hand or other location that the watch body 1020 is placed or held.

In some embodiments, the peripherals interface 1061 includes an NFC component 1069, a global-position system (GPS) component 1070, a long-term evolution (LTE) component 1071, and/or a Wi-Fi and/or Bluetooth communication component 1072. In some embodiments, the peripherals interface 1061 includes one or more buttons 1073 (e.g., the peripheral buttons 1023 and 1027 in FIG. 10A), which, when selected by a user, cause operations to be performed at the watch body 1020. In some embodiments, the peripherals interface 1061 includes one or more indicators, such as a light emitting diode (LED), to provide a user with visual indicators (e.g., message received, low battery, an active microphone, and/or a camera, etc.).

The watch body 1020 can include at least one display 1005 for displaying visual representations of information or data to the user, including user-interface elements and/or three-dimensional (3D) virtual objects. The display can also include a touch screen for inputting user inputs, such as touch gestures, swipe gestures, and the like. The watch body 1020 can include at least one speaker 1074 and at least one microphone 1075 for providing audio signals to the user and receiving audio input from the user. The user can provide user inputs through the microphone 1075 and can also receive audio output from the speaker 1074 as part of a haptic event provided by the haptic controller 1078. The watch body 1020 can include at least one camera 1025, including a front-facing camera 1025A and a rear-facing camera 1025B. The cameras 1025 can include ultra-wide-angle cameras, wide-angle cameras, fish-eye cameras, spherical cameras, telephoto cameras, a depth-sensing cameras, or other types of cameras.

The watch body computing system 1060 can include one or more haptic controllers 1078 and associated componentry (e.g., haptic devices 1076) for providing haptic events at the watch body 1020 (e.g., a vibrating sensation or audio output in response to an event at the watch body 1020). The haptic controllers 1078 can communicate with one or more haptic devices 1076, such as electroacoustic devices, including a speaker of the one or more speakers 1074 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1078 can provide haptic events to respective haptic actuators that are capable of being sensed by a user of the watch body 1020. In some embodiments, the one or more haptic controllers 1078 can receive input signals from an application of the applications 1082.

In some embodiments, the computer system 1030 and/or the computer system 1060 can include memory 1080, which can be controlled by a memory controller of the one or more controllers 1077 and/or one or more processors 1079. In some embodiments, software components stored in the memory 1080 include one or more applications 1082 configured to perform operations at the watch body 1020. In some embodiments, the one or more applications 1082 include games, word processors, messaging applications, calling applications, web browsers, social media applications, media streaming applications, financial applications, calendars, clocks, etc. In some embodiments, software components stored in the memory 1080 include one or more communication interface modules 1083 as defined above. In some embodiments, software components stored in the memory 1080 include one or more graphics modules 1084 for rendering, encoding, and/or decoding audio and/or visual data; and one or more data management modules 1085 for collecting, organizing, and/or providing access to the data 1087 stored in memory 1080. In some embodiments, software components stored in the memory 1080 include a first processor module 1086A and a second processor module 1087A, configured to perform the features described above in reference to FIGS. 1A-8B. In some embodiments, one or more of applications 1082 and/or one or more modules can work in conjunction with one another to perform various tasks at the watch body 1020.

In some embodiments, software components stored in the memory 1080 can include one or more operating systems 1081 (e.g., a Linux-based operating system, an Android operating system, etc.). The memory 1080 can also include data 1087. The data 1087 can include profile data 1088A, sensor data 1089A, media content data 1090, application data 1091, first processor data 1092A, and second processor data 1093A, which store data related to the performance of the features described above in reference to FIGS. 1A-8B.

It should be appreciated that the watch body computing system 1060 is an example of a computing system within the watch body 1020, and that the watch body 1020 can have more or fewer components than shown in the watch body computing system 1060, combine two or more components, and/or have a different configuration and/or arrangement of the components. The various components shown in watch body computing system 1060 are implemented in hardware, software, firmware, or a combination thereof, including one or more signal processing and/or application-specific integrated circuits.

Turning to the wearable band computing system 1030, one or more components that can be included in the wearable band 1010 are shown. The wearable band computing system 1030 can include more or fewer components than shown in the watch body computing system 1060, combine two or more components, and/or have a different configuration and/or arrangement of some or all of the components. In some embodiments, all, or a substantial portion of the components of the wearable band computing system 1030 are included in a single integrated circuit. Alternatively, in some embodiments, components of the wearable band computing system 1030 are included in a plurality of integrated circuits that are communicatively coupled. As described above, in some embodiments, the wearable band computing system 1030 is configured to couple (e.g., via a wired or wireless connection) with the watch body computing system 1060, which allows the computing systems to share components, distribute tasks, and/or perform other operations described herein (individually or as a single device).

The wearable band computing system 1030, similar to the watch body computing system 1060, can include one or more processors 1049, one or more controllers 1047 (including one or more haptics controller 1048), a peripherals interface 1031 that can include one or more sensors 1013 and other peripheral devices, power source (e.g., a power system 1056), and memory (e.g., a memory 1050) that includes an operating system (e.g., an operating system 1051), data (e.g., data 1054 including profile data 1088B, sensor data 1089B, first processor data 1092B, second processor data 1093B, etc.), and one or more modules (e.g., a communications interface module 1052, a data management module 1053, a first processor module 1086B, a second processor module 1087B, etc.).

The one or more sensors 1013 can be analogous to sensors 1021 of the computer system 1060 in light of the definitions above. For example, sensors 1013 can include one or more coupling sensors 1032, one or more SpO2 sensors 1034, one or more EMG sensors 1035, one or more capacitive sensors 1036, one or more heart rate sensors 1037, and one or more IMU sensors 1038.

The peripherals interface 1031 can also include other components analogous to those included in the peripheral interface 1061 of the computer system 1060, including an NFC component 1039, a GPS component 1040, an LTE component 1041, a Wi-Fi and/or Bluetooth communication component 1042, and/or one or more haptic devices 1076 as described above in reference to peripherals interface 1061. In some embodiments, the peripherals interface 1031 includes one or more buttons 1043, a display 1033, a speaker 1044, a microphone 1045, and a camera 1055. In some embodiments, the peripherals interface 1031 includes one or more indicators, such as an LED.

It should be appreciated that the wearable band computing system 1030 is an example of a computing system within the wearable band 1010, and that the wearable band 1010 can have more or fewer components than shown in the wearable band computing system 1030, combine two or more components, and/or have a different configuration and/or arrangement of the components. The various components shown in wearable band computing system 1030 can be implemented in one or a combination of hardware, software, and firmware, including one or more signal processing and/or application-specific integrated circuits.

The wrist-wearable device 1000 with respect to FIGS. 10A is an example of the wearable band 1010 and the watch body 1020 coupled, so the wrist-wearable device 1000 will be understood to include the components shown and described for the wearable band computing system 1030 and the watch body computing system 1060. In some embodiments, wrist-wearable device 1000 has a split architecture (e.g., a split mechanical architecture or a split electrical architecture) between the watch body 1020 and the wearable band 1010. In other words, all of the components shown in the wearable band computing system 1030 and the watch body computing system 1060 can be housed or otherwise disposed in a combined watch device 1000, or within individual components of the watch body 1020, wearable band 1010, and/or portions thereof (e.g., a coupling mechanism 1016 of the wearable band 1010).

The techniques described above can be used with any device for sensing neuromuscular signals, including the arm-wearable devices of FIG. 10A-10B, but could also be used with other types of wearable devices for sensing neuromuscular signals (such as body-wearable or head-wearable devices that might have neuromuscular sensors closer to the brain or spinal column).

In some embodiments, a wrist-wearable device 1000 can be used in conjunction with a head-wearable device described below (e.g., AR device 1100 and VR device 1110), and the wrist-wearable device 1000 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 1100 and VR device 1110.

### Example Head-Wearable Devices

FIGS. 11A, 11B-1, 11B-2, and 11C show example head-wearable devices, in accordance with some embodiments. Head-wearable devices can include, but are not limited to, AR devices 1110 (e.g., AR or smart eyewear devices, such as smart glasses, smart monocles, smart contacts, etc.), VR devices 1110 (e.g., VR headsets, head-mounted displays (HMD)s, etc.), or other ocularly coupled devices. The AR devices 1100 and the VR devices 1110 are instances of the head-wearable devices (e.g., user device 105, 205, 301, 405, and 505) described in reference to FIGS. 1A-5B herein, such that the head-wearable device should be understood to have the features of the AR devices 1100 and/or the VR devices 1110, and vice versa. The AR devices 1100 and the VR devices 1110 can perform various functions and/or operations associated with navigating through user interfaces and selectively opening applications, as well as the functions and/or operations described above with reference to FIGS. 1A-5B.

In some embodiments, an AR system (e.g., AR systems 900a-900d; FIGS. 9A-9D-2) includes an AR device 1100 (as shown in FIG. 11A) and/or VR device 1110 (as shown in FIGS. 11B-1-B-2). In some embodiments, the AR device 1100 and the VR device 1110 can include one or more analogous components (e.g., components for presenting interactive artificial-reality environments, such as processors, memory, and/or presentation devices, including one or more displays and/or one or more waveguides), some of which are described in more detail with respect to FIG. 11C. The head-wearable devices can use display projectors (e.g., display projector assemblies 1107A and 1107B) and/or waveguides for projecting representations of data to a user. Some embodiments of head-wearable devices do not include displays.

FIG. 11A shows an example visual depiction of the AR device 1100 (e.g., which may also be described herein as augmented-reality glasses and/or smart glasses). The AR device 1100 can work in conjunction with additional electronic components that are not shown in FIGS. 11A, such as a wearable accessory device and/or an intermediary processing device, in electronic communication or otherwise configured to be used in conjunction with the AR device 1100. In some embodiments, the wearable accessory device and/or the intermediary processing device may be configured to couple with the AR device 1100 via a coupling mechanism in electronic communication with a coupling sensor 1124, where the coupling sensor 1124 can detect when an electronic device becomes physically or electronically coupled with the AR device 1100. In some embodiments, the AR device 1100 can be configured to couple to a housing (e.g., a portion of frame 1104 or temple arms 1105), which may include one or more additional coupling mechanisms configured to couple with additional accessory devices. The components shown in FIG. 11A can be implemented in hardware, software, firmware, or a combination thereof, including one or more signal-processing components and/or application-specific integrated circuits (ASICs).

The AR device 1100 includes mechanical glasses components, including a frame 1104 configured to hold one or more lenses (e.g., one or both lenses 1106-1 and 1106-2). One of ordinary skill in the art will appreciate that the AR device 1100 can include additional mechanical components, such as hinges configured to allow portions of the frame 1104 of the AR device 1100 to be folded and unfolded, a bridge configured to span the gap between the lenses 1106-1 and 1106-2 and rest on the user's nose, nose pads configured to rest on the bridge of the nose and provide support for the AR device 1100, earpieces configured to rest on the user's ears and provide additional support for the AR device 1100, temple arms 1105 configured to extend from the hinges to the earpieces of the AR device 1100, and the like. One of ordinary skill in the art will further appreciate that some examples of the AR device 1100 can include none of the mechanical components described herein. For example, smart contact lenses configured to present artificial-reality to users may not include any components of the AR device 1100.

The lenses 1106-1 and 1106-2 can be individual displays or display devices (e.g., a waveguide for projected representations). The lenses 1106-1 and 1106-2 may act together or independently to present an image or series of images to a user. In some embodiments, the lenses 1106-1 and 1106-2 can operate in conjunction with one or more display projector assemblies 1107A and 1107B to present image data to a user. While the AR device 1100 includes two displays, embodiments of this disclosure may be implemented in AR devices with a single near-eye display (NED) or more than two NEDs.

The AR device 1100 includes electronic components, many of which will be described in more detail below with respect to FIG. 11C. Some example electronic components are illustrated in FIG. 11A, including sensors 1123-1, 1123-2, 1123-3,. 1123-4, 1123-5, and 1123-6, which can be distributed along a substantial portion of the frame 1104 of the AR device 1100. The distinct types of sensors are described below in reference to FIG. 11C. The AR device 1100 also includes a left camera 1139A and a right camera 1139B, which are located on different sides of the frame 1104. And the eyewear device includes one or more processors 1148A and 1148B (e.g., an integral microprocessor, such as an ASIC) that is embedded into a portion of the frame 1104.

FIGS. 11B-1 and 11B-2 show an example visual depiction of the VR device 1110 (e.g., a head-mounted display (HMD) 1112, also referred to herein as an artificial-reality headset, a head-wearable device, a VR headset, etc.). The HMD 1112 includes a front body 1114 and a frame 1116 (e.g., a strap or band) shaped to fit around a user's head. In some embodiments, the front body 1114 and/or the frame 1116 includes one or more electronic elements for facilitating presentation of and/or interactions with an AR and/or VR system (e.g., displays, processors (e.g., processor 1148A-1), IMUs, tracking emitter or detectors, sensors, etc.). In some embodiments, the HMD 1112 includes output audio transducers (e.g., an audio transducer 1118-1), as shown in FIG. 11B-2. In some embodiments, one or more components, such as the output audio transducer(s) 1118-1 and the frame 1116, can be configured to attach and detach (e.g., are detachably attachable) to the HMD 1112 (e.g., a portion or all of the frame 1116, and/or the output audio transducer 1118-1), as shown in FIG. 11B-2. In some embodiments, coupling a detachable component to the HMD 1112 causes the detachable component to come into electronic communication with the HMD 1112. The VR device 1110 includes electronic components, many of which will be described in more detail below with respect to FIG. 11C.

FIG. 11B-1 to 11B-2 also show that the VR device 1110 one or more cameras, such as the left camera 1139A and the right camera 1139B, which can be analogous to the left and right cameras on the frame 1104 of the AR device 1100. In some embodiments, the VR device 1110 includes one or more additional cameras (e.g., cameras 1139C and 1139D), which can be configured to augment image data obtained by the cameras 1139A and 1139B by providing more information. For example, the camera 1139C can be used to supply color information that is not discerned by cameras 1139A and 1139B. In some embodiments, one or more of the cameras 1139A to 1139D can include an optional IR cut filter configured to remove IR light from being received at the respective camera sensors.

The VR device 1110 can include a housing 1190 storing one or more components of the VR device 1110 and/or additional components of the VR device 1110. The housing 1190 can be a modular electronic device configured to couple with the VR device 1110 (or an AR device 1100) and supplement and/or extend the capabilities of the VR device 1110 (or an AR device 1100). For example, the housing 1190 can include additional sensors, cameras, power sources, processors (e.g., processor 1148A-2), etc. to improve and/or increase the functionality of the VR device 1110. Examples of the different components included in the housing 1190 are described below in reference to FIG. 11C.

Artificial-reality systems may include a variety of types of visual feedback mechanisms. For example, display devices in the AR devices 1100 and/or the VR devices 1110 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 1100 and/or the VR device 1110 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 1100 and the VR device 1110, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 1100 and/or the VR device 1110 can include haptic feedback systems. The haptic feedback systems may provide distinct types of cutaneous feedback, including vibration, force, traction, shear, texture, and/or temperature. The haptic feedback systems may also provide distinct types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 1000, etc.), and/or other devices described herein.

FIG. 11C illustrates a computing system 1120 and an optional housing 1190, each of which show components that can be included in a head-wearable device (e.g., the AR device 1100 and/or the VR device 1110). In some embodiments, more or less components can be included in the optional housing 1190 depending on practical restraints of the respective head-wearable device being described. Additionally, or alternatively, the optional housing 1190 can include additional components to expand and/or augment the functionality of a head-wearable device.

In some embodiments, the computing system 1120 and/or the optional housing 1190 can include one or more peripheral interfaces 1122A and 1122B, one or more power systems 1142A and 1142B (including charger input 1143, PMIC 1144, and battery 1145), one or more controllers 1146A 1146B (including one or more haptic controllers 1147), one or more processors 1148A and 1148B (as defined above, including any of the examples provided), and memory 1150A and 1150B, which can all be in electronic communication with each other. For example, the one or more processors 1148A and/or 1148B can be configured to execute instructions stored in the memory 1150A and/or 1150B, which can cause a controller of the one or more controllers 1146A and/or 1146B to cause operations to be performed at one or more peripheral devices of the peripheral interfaces 1122A and/or 1122B. In some embodiments, each operation described can occur based on electrical power provided by the power system 1142A and/or 1142B.

In some embodiments, the peripherals interface 1122A can include one or more devices configured to be part of the computing system 1120, many of which have been defined above and/or described with respect to wrist-wearable devices shown in FIGS. 10A and 10B. For example, the peripherals interface can include one or more sensors 1123A. Some example sensors include: one or more coupling sensors 1124, one or more acoustic sensors 1125, one or more imaging sensors 1126, one or more EMG sensors 1127, one or more capacitive sensors 1128, and/or one or more IMUs 1129. In some embodiments, the sensors 1123A further include depth sensors 1167, light sensors 1168 and/or any other types of sensors defined above or described with respect to any other embodiments discussed herein.

In some embodiments, the peripherals interface can include one or more additional peripheral devices, including one or more NFC devices 1130, one or more GPS devices 1131, one or more LTE devices 1132, one or more WiFi and/or Bluetooth devices 1133, one or more buttons 1134 (e.g., including buttons that are slidable or otherwise adjustable), one or more displays 1135A, one or more speakers 1136A, one or more microphones 1137A, one or more cameras 1138A (e.g., including the a first camera 1139-1 through nth camera 1139-n, which are analogous to the left camera 1139A and/or the right camera 1139B); and/or any other types of peripheral devices defined above or described with respect to any other embodiments discussed herein.

The head-wearable devices can include a variety of types of visual feedback mechanisms (e.g., presentation devices). For example, display devices in the AR device 1100 and/or the VR device 1110 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1135A can be coupled to each of the lenses 1106-1 and 1106-2 of the AR device 1100. The displays 1135A coupled to each of the lenses 1106-1 and 1106-2 can act together or independently to present an image or series of images to a user. In some embodiments, the AR device 1100 and/or the VR device 1110 includes a single display 1135A (e.g., a near-eye display) or more than two displays 1135A.

In some embodiments, a first set of one or more displays 1135A can be used to present an augmented-reality environment, and a second set of one or more display devices 1135A can be used to present a virtual-reality environment. In some embodiments, one or more waveguides are used in conjunction with presenting artificial-reality content to the user of the AR device 1100 and/or the VR device 1110 (e.g., as a means of delivering light from a display projector assembly and/or one or more displays 1135A to the user's eyes). In some embodiments, one or more waveguides are fully or partially integrated into the AR device 1100 and/or the VR device 1110. Additionally, or alternatively to display screens, some artificial-reality systems include one or more projection systems. For example, display devices in the AR device 1100 and/or the VR device 1110 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 1135A.

In some embodiments of the head-wearable devices, ambient light, and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 1135A for presenting information to users. For example, an external display 1135A can be used to show a current battery level, network activity (e.g., connected, disconnected, etc.), current activity (e.g., playing a game, in a call, in a meeting, watching a movie, etc.), and/or other relevant information. In some embodiments, the external displays 1135A can be used to communicate with others. For example, a user of the head-wearable device can cause the external displays 1135A to present a do not disturb notification. The external displays 1135A can also be used by the user to share any information captured by the one or more components of the peripherals interface 1122A and/or generated by head-wearable device (e.g., during operation and/or performance of one or more applications).

The memory 1150A can include instructions and/or data executable by one or more processors 1148A (and/or processors 1148B of the housing 1190) and/or a memory controller of the one or more controllers 1146A (and/or controller 1146B of the housing 1190). The memory 1150A can include one or more operating systems 1151; one or more applications 1152; one or more communication interface modules 1153A; one or more graphics modules 1154A; one or more AR processing modules 1155A; first processor module 1156A; second processor module 1157A; and/or any other types of modules or components defined above or described with respect to any other embodiments discussed herein.

The data 1160 stored in memory 1150A can be used in conjunction with one or more of the applications and/or programs discussed above. The data 1160 can include profile data 1161; sensor data 1162; media content data 1163; AR application data 1164; first processor data 1165A; second processor data 1166A; and/or any other types of data defined above or described with respect to any other embodiments discussed herein.

In some embodiments, the controller 1146A of the head-wearable devices processes information generated by the sensors 1123A on the head-wearable devices and/or another component of the head-wearable devices and/or communicatively coupled with the head-wearable devices (e.g., components of the housing 1190, such as components of peripherals interface 1122B). For example, the controller 1146A can process information from the acoustic sensors 1125 and/or image sensors 1126. For each detected sound, the controller 1146A can perform a direction of arrival (DOA) estimation to estimate a direction from which the detected sound arrived at a head-wearable device. As one or more of the acoustic sensors 1125 detects sounds, the controller 1146A can populate an audio data set with the information (e.g., represented by sensor data 1162).

In some embodiments, a physical electronic connector can convey information between the head-wearable devices and another electronic device, and/or between one or more processors 1148A of the head-wearable devices and the controller 1146A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include distinct types of computer vision components and subsystems. For example, the AR device 1100 and/or the VR device 1110 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 11B-1 and 11B-2 show the VR device 1110 having cameras 1139A-1139D, which can be used to provide depth information for creating a voxel field and a two-dimensional mesh to provide object information to the user to avoid collisions.

The optional housing 1190 can include analogous components to those describe above with respect to the computing system 1120. For example, the optional housing 1190 can include a respective peripherals interface 1122B including more or less components to those described above with respect to the peripherals interface 1122A. As described above, the components of the optional housing 1190 can be used augment and/or expand on the functionality of the head-wearable devices. For example, the optional housing 1190 can include respective sensors 1123B, speakers 1136B, displays 1135B, microphones 1137B, cameras 1138B, and/or other components to capture and/or present data. Similarly, the optional housing 1190 can include one or more processors 1148B, controllers 1146B, and/or memory 1150B (including respective communication interface modules 1153B; one or more graphics modules 1154B; one or more AR processing modules 1155B, etc.) that can be used individually and/or in conjunction with the components of the computing system 1120.

The techniques described above in FIGS. 11A-11C can be used with different head-wearable devices. In some embodiments, the head-wearable devices (e.g., the AR device 1100 and/or the VR device 1110) can be used in conjunction with one or more wearable device such as a wrist-wearable device 1000 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium storing one or more programs configured for execution by one or more processors, the one or more programs including instructions for:
causing, by a first processor, display of a first user interface;
receiving, by the first processor, a first user input requesting display of a second user interface instead of the first user interface;
in accordance with determining that the first user input requires performance of an operation that does not satisfy first processor performance criteria, sending, by the first processor and to a second processor, a first wake-up message based on the first user input;
causing, by the first processor and based on the first user input, partial display of the second user interface; and
in conjunction with handing-off display control for the second user interface to the second processor, causing, by the second processor, a complete display of the second user interface.

2. The non-transitory computer-readable storage medium of claim 1, further storing instructions for:
prior to receiving the first user input, receiving, by the first processor and from the second processor, a first set of pre-rendered user interface elements for the second user interface, wherein causing, by the first processor, the partial display of the second user interface is based on rendering at least a portion of the first set of pre-rendered user interface elements for the second user interface.

3. The non-transitory computer-readable storage medium of claim 2, further storing instructions for:
receiving, by the second processor, a second user input requesting display of a third user interface instead of the second user interface; and
in accordance with determining that the second user input requests performance of an operation that satisfies the first processor performance criteria, sending, by the second processor and to the first processor, a second wake-up message based on the second user input.

4. The non-transitory computer-readable storage medium of claim 3, further storing instructions for:
determining, by the second processor, that the second user input is an incomplete user input; and
aborting sending of the second wake-up message to the first processor.

5. The non-transitory computer-readable storage medium of claim 3, further storing instructions for:
causing, by the second processor and based on the second user input requesting display of the third user interface, display of the third user interface;
based on a timestamp associated with the second wake-up message and a predetermined initialization time for the first processor, sending, by the second processor and to the first processor, a second set of pre-rendered user interface elements for the third user interface; and
in conjunction with transferring display control for the third user interface to the first processor, causing, by the first processor, display of the third user interface based on the second set of pre-rendered user interface elements for the third user interface.

6. The non-transitory computer-readable storage medium of claim 5, further storing instructions for:
receiving, by the first processor and from the second processor, a hand-off message for the third user interface; and
causing, by the first processor and based on the hand-off message, the complete display of the third user interface.

7. The non-transitory computer-readable storage medium of claim 1, wherein the first processor consumes lower operating power than the second processor.

8. The non-transitory computer-readable storage medium of claim 1, wherein causing, by the first processor and based on the first user input, the partial display of the second user interface is further based on a timestamp for the first wake-up message and a predetermined initialization time associated with the second processor.

9. A method for causing display of user interface screens by a first processor and a second processor of a user device, the method comprising:
causing, by a first processor, display of a first user interface;
receiving, by the first processor, a first user input for the first user interface, wherein the first user input requests display of a second user interface instead of the first user interface;
in accordance with determining that the first user input requires performance of an operation that does not satisfy first processor performance criteria, sending, by the first processor and to a second processor, a first wake-up message based on the first user input;
causing, by the first processor and based on the first user input, partial display of the second user interface; and
in conjunction with handing-off display control for the second user interface to the second processor, causing, by the second processor, a complete display of the second user interface.

10. The method of claim 9, further comprising:
prior to receiving the first user input, receiving, by the first processor and from the second processor, a first set of pre-rendered user interface elements for the second user interface, wherein causing, by the first processor, the partial display of the second user interface is based on rendering at least a portion of the first set of pre-rendered user interface elements for the second user interface.

11. The method of claim 10, further comprising:
receiving, by the second processor, a second user input requesting display of a third user interface instead of the second user interface; and
in accordance with determining that the second user input requests performance of an operation that satisfies the first processor performance criteria, sending, by the second processor and to the first processor, a second wake-up message based on the second user input.

12. The method of claim 11, further comprising:
determining, by the second processor, that the second user input is an incomplete user input; and
aborting sending of the second wake-up message to the first processor.

13. The method of claim 11, further comprising:
causing, by the second processor and based on the second user input requesting display of the third user interface, display of the third user interface;
based on a timestamp associated with the second wake-up message and a predetermined initialization time for the first processor, sending, by the second processor and to the first processor, a second set of pre-rendered user interface elements for the third user interface; and
in conjunction with transferring display control for the third user interface to the first processor, causing, by the first processor, display of the third user interface based on the second set of pre-rendered user interface elements for the third user interface.

14. The method of claim 13, further comprising:
receiving, by the first processor and from the second processor, a hand-off message for the third user interface; and
causing, by the first processor and based on the hand-off message, the complete display of the third user interface.

15. The method of claim 9, wherein the first processor consumes lower operating power than the second processor.

16. The method of claim 9, wherein causing, by the first processor and based on the first user input, the partial display of the second user interface is further based on a timestamp for the first wake-up message and a predetermined initialization time associated with the second processor.

17. A system comprising:
a first processor;
a second processor communicatively coupled to the first processor;
a first non-transitory memory coupled to the first processor storing one or more programs to be executed by the first processor, the one or more programs including instructions for:
causing display of a first user interface;
receiving a first user input for the first user interface, wherein the first user input requests display of a second user interface instead of the first user interface;
in accordance with determining that the first user input requires performance of an operation that does not satisfy first processor performance criteria, sending, by the first processor and to the second processor, a first wake-up message based on the first user input; and
causing, based on the first user input, partial display of the second user interface; and
a second non-transitory memory coupled to the second processor storing one or more programs to be executed by the second processor, the one or more programs including instructions for:
receiving the first wake-up message; and
causing a complete display of the second user interface.

18. The system of claim 17, further comprising:
prior to receiving the first user input, receiving, by the first processor and from the second processor, a first set of pre-rendered user interface elements for the second user interface; and
receiving, by the first processor and from the second processor, a second set of pre-rendered user interface elements for a third user interface, wherein causing the display of the second user interface is based on rendering at least a portion of the first set of pre-rendered user interface elements for the second user interface.

19. The system of claim 18, the second non-transitory memory coupled to the second processor further storing instructions for:
receiving a second user input requesting display of a third user interface instead of the second user interface; and
in accordance with determining that the second user input requests performance of an operation that satisfies the first processor performance criteria, sending, to the first processor, a second wake-up message based on the second user input.

20. The system of claim 19, the second non-transitory memory coupled to the second processor further storing instructions for:
determining that second first user input is an incomplete user input; and
aborting sending of the second wake-up message to the second processor.
